(19) United States
(12) Patent Application Publication
(10) Pub. No.: US 2016/0205012 A1
(43) Pub. Date: Jul. 14, 2016

(54) DEVICE AND METHOD FOR PATH CALCULATION

(71) Applicant: FUJITSU LIMITED, Kawasaki-shi (JP)

(72) Inventors: TAKEHIRO SUZUKI, Kawasaki (JP); Masakazu Bamba, Kawasaki (JP)

(73) Assignee: FUJITSU LIMITED, Kawasaki-shi (JP)

(21) Appl. No.: 14/988,936

(22) Filed: Jan. 6, 2016

(30) Foreign Application Priority Data
Jan. 13, 2015 (JP) 2015-004526

(51) Int. Cl. H04L 12/751; H04L 12/24

(52) U.S. Cl. CPC H04L 45/02; H04L 41/12

(57) ABSTRACT

A path calculation device includes: a first storage that stores first topology information for indicating a topology of a network; a second storage that stores second topology information generated from the first topology information stored in the first storage; and a processor that determines a path between a start point and an end point based on the second topology information stored in the second storage and provides path information for indicating the determined path to the network when the path calculation device receives a path calculation request that includes information for indicating the start point and the end point from the network. The processor updates the second topology information stored in the second storage based on the determined path.

### CROSS-REFERENCE TO RELATED APPLICATION

This application is based upon and claims the benefit of priority of the prior Japanese Patent Application No. 2015-004526, filed on Jan. 13, 2015, the entire contents of which are incorporated herein by reference.

### FIELD

The embodiments discussed herein are related to a device and a method for performing a path calculation in response to a path calculation request.

### BACKGROUND

A transmission network in which a data plane and a control plane are separated has been in practical use. The data plane transmits user traffic. The control plane performs communication for controlling the transmission network. For example, the control plane realizes a path establishment/deletion and a protection switch.

FIG. 1 illustrates an example of a transmission network that includes a data plane and a control plane. In the example illustrated in FIG. 1, the transmission network includes nodes A to F. User traffic is transmitted in the data plane.

A path for transmitting user traffic is established in advance of communication. Here, a node in the transmission network makes a request for a path calculation device (PCE: path computation element) via the control plane to perform a path calculation. The PCE performs a path calculation for determining a route in which a bandwidth has been ensured. Then, the control plane establishes a path in the data plane according to a result of the calculation by the PCE.

FIG. 2 illustrates an example of a path establishment by a PCE. In this example, a PCE 500 includes a storage 510, a processor 520, and a communication IF unit 530, as illustrated in FIG. 2. The storage 510 includes a database (TED: traffic engineering database) 511. The TED 511 stores therein topology information that indicates a topology of the data plane in the transmission network. The processor 520 includes a path calculator 521 that performs path calculation in response to a path calculation request. The operations of the PCE will be described below:

(1) The PCE 500 acquires adjacent node information which each node advertises in the control plane. Then, topology information is generated from the acquired information and is stored in the TED 511.

(2) The PCE 500 receives a path calculation request from a node via the control plane. In the example illustrated in FIG. 2, a node N1 issues a path calculation request. The path calculation request includes information that designates a start point and an end point of a path, and a constraint condition (such as a designation of a bandwidth). Then, this path calculation request is given to a path calculator 521 via the communication IF unit 530.

(3) The path calculator 521 reads topology information from the TED 511, and performs a path calculation. A result of the path calculation includes information that indicates a route of a path between the designated start point and end point. Then, the path calculator 521 transmits the calculation result to the node that has issued the path calculation request (in FIG. 2, the node N1).

(4) The control plane establishes a path in the data plane according to the path calculation result. When the path establishment is completed, information that indicates a topology update of the data plane is reported from the control plane to the PCE 500. Then, the TED 511 is updated according to the report.

Related technologies are disclosed in, for example, Japanese Laid-open Patent Publication No. 2005-323129 and Japanese Laid-open Patent Publication No. 2009-225314.

As described above, when receiving a path calculation request from a node via the control plane, the PCE performs a path calculation using the topology information stored in the TED. Then, when a path establishment is completed, the topology information stored in the TED is updated.

However, there is a possibility that the PCE will not be able to perform a correct path calculation when receiving a plurality of path calculation requests at the same time or in a short period of time. For example, it is assumed that a path calculation request 1 is issued by the node N1, and immediately after that, a path calculation request 2 is issued by the node N2. In this case, the PCE performs a path calculation for the path calculation request 1 using the topology information stored in the TED, and transmits a result of the calculation to the node N1. Next, the PCE performs a path calculation for the path calculation request 2 using the topology information stored in the TED. However, when a calculated path is established in the transmission network, the establishment of the new path is advertised in the control plane and is reflected in the TED, but there is a time lag from when the new path is actually established until the new path is reflected in the TED. Thus, there is a possibility that the PCE has not received a result of a path establishment that corresponds to the path calculation request 1 before the path calculation for the path calculation request 2 is performed. In this case, information related to a path that corresponds to the path calculation request 1 is not reflected in the topology information stored in the TED. In other words, the PCE may perform a path calculation based on topology information that does not indicate the latest network topology. This results in providing a result of an inappropriate calculation to the node N2, and a path establishment may fail.

This problem may be solved by, for example, performing the next path calculation after a path establishment that corresponds to a previous path calculation request is completed. However, such a method needs a longtime to process a plurality of path calculation requests.

### SUMMARY

According to an aspect of the embodiments, a path calculation device includes: a first storage that stores first topology information for indicating a topology of a network; a second storage that stores second topology information generated from the first topology information stored in the first storage; and a processor that determines a path between a start point and an end point based on the second topology information stored in the second storage and provides path information for indicating the determined path to the network when the path calculation device receives a path calculation request that includes information for indicating the start point and the endpoint from the network. The processor updates the second topology information stored in the second storage based on the determined path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a transmission network;

FIG. 2 illustrates an example of a path establishment;

FIG. 3 illustrates an example of a configuration of a path calculation device according to a first embodiment of the present invention;

FIGS. 4 and 5 illustrate operations of the path calculation device according to the first embodiment;

FIG. 6 illustrates a transition of an operation state of the path calculation device;

FIG. 7 is a flowchart that illustrates an operation of the path calculation device according to the first embodiment;

FIGS. 8-11 illustrate examples of operations of the path calculation device according to the first embodiment;

FIG. 12 is a time chart of a path establishment illustrated in FIGS. 8-11;

FIG. 13 is a time chart that illustrates a case in which a path calculation is performed without using the topology information for a path calculation;

FIG. 14 illustrates an example of a configuration of a path calculation device according to a second embodiment of the present invention;

FIG. 15 illustrates an example of a configuration of a topology information database and a configuration of a secondary database;

FIG. 16 illustrates an example of a management table;

FIG. 17 illustrates an example of messages used between a path computation element PCE and a node;

FIGS. 18-21 illustrate operations of the path calculation device according to the second embodiment;

FIG. 22 is a flowchart that illustrates an operation of the path calculation device according to the second embodiment;

FIGS. 23 and 24 are flowcharts that illustrate a path calculation process of the second embodiment;

FIGS. 25-32 illustrate examples of operations of the path calculation device according to the second embodiment; and

FIG. 33 illustrates an example of a hardware configuration of a path calculation device.

### DESCRIPTION OF EMBODIMENTS

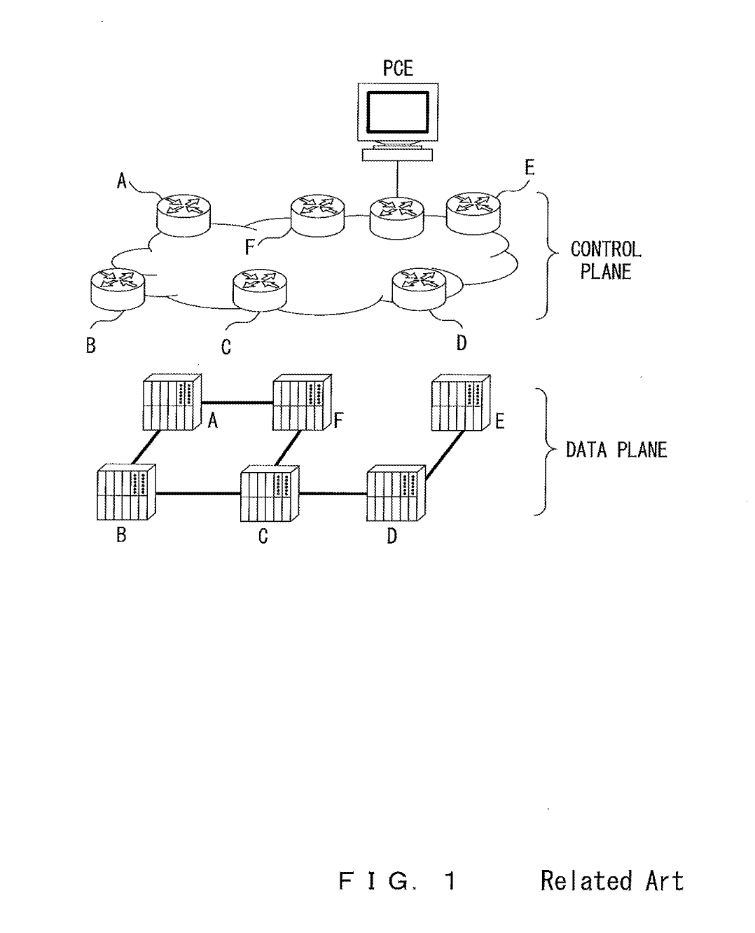

A path calculation device according to embodiments of the present invention determines a route of a path in response to a request from a network. According to one embodiment, a network is divided into a data plane and a control plane, as illustrated in FIG. 1. In this case, a path calculation device determines a path in response to a path calculation request received from a node via the control plane, and provides path information that indicates a result of the calculation to the node that has issued the path calculation request. Then, the control plane establishes a path in the data plane according to the path information generated by the path calculation device. In the following descriptions, a PCE (path computation element) is an example of a path calculation device.

### First Embodiment

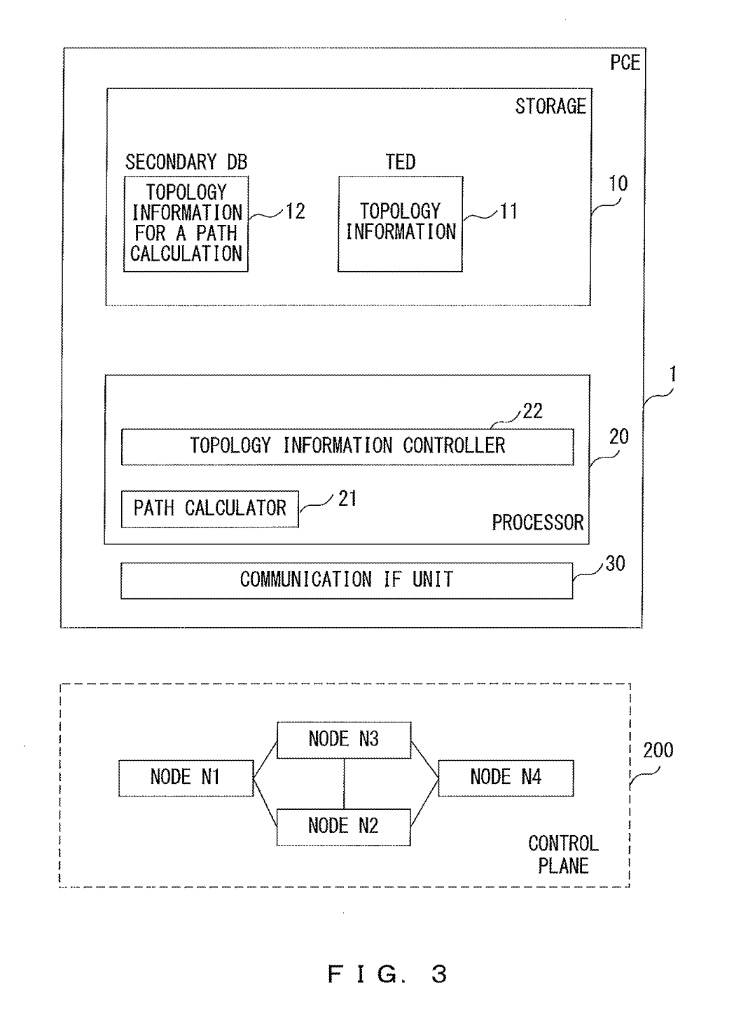

FIG. 3 illustrates an example of a configuration of a path calculation device according to a first embodiment of the present invention. As illustrated in FIG. 3, a path computation element PCE 1 of the first embodiment includes a storage 10, a processor 20, and a communication IF unit 30.

The storage 10 is implemented by, for example, a semiconductor memory. However, the storage 10 may be implemented by use of other recording media. Note that the storage 10 includes a topology information database (TED: traffic engineering database) 11 and a secondary database (a secondary DB) 12.

The topology information database TED 11 stores therein topology information that is advertised in a control plane 200 of a transmission network. The topology information indicates a topology of a data plane. In this embodiment, the topology information also includes information that indicates allocation of resources in the data plane.

The secondary database 12 stores therein topology information that is generated from the topology information stored in the topology information database TED 11. As an example, the topology information stored in the topology information database TED 11 is copied to the secondary database 12 upon initial operation or when a synchronizing process is performed. However, the topology information stored in the secondary database 12 is updated according to a result of a path calculation performed by the processor 20. On the other hand, the topology information stored in the topology information database TED 11 is not updated according to a result of a path calculation performed by the processor 20. In the following descriptions, the topology information stored in the secondary database 12 may be referred to as “topology information for a path calculation”.

The processor 20 is implemented by, for example, a CPU. In other words, the processor 20 is able to determine a path in response to a received path calculation request by executing a given program. The processor 20 includes a path calculator 21 and a topology information controller 22.

When receiving a path calculation request from anode in the transmission network via the control plane 200, the path calculator 21 performs a path calculation by use of the topology information for a path calculation stored in the secondary database 12. The path calculation request includes information that indicates a start point and an end point of a path established in the data plane, and also includes a constraint condition for the path. The constraint condition includes, for example, a bandwidth requested by a user. A result of the calculation performed by the path calculator 21 is transmitted to the node that has issued the path calculation request. The result of the calculation performed by the path calculator 21 includes path information that indicates a route on which the path between the start point and the end point that have been designated in the path calculation request is established, and a bandwidth of the path.

The topology information controller 22 updates the topology information database TED 11 and the secondary database 12. For example, when the path computation element PCE 1 receives topology information that is advertised in the control plane 200, the topology information controller 22 updates the topology information database TED 11 using the received topology information. When a path calculation is performed by the path calculator 21, the topology information controller 22 updates the secondary database 12 according to a result of the calculation. Further, the topology information controller 22 is able to establish synchronization between the topology information database TED 11 and the secondary database 12 as needed. In other words, the topology information controller 22 is able to update the secondary database 12 so that the topology information stored in the topology information database TED 11 matches the topology information for a path calculation stored in the secondary database 12. In this case, the secondary database 12 is overwritten with the topology information stored in the topology information database TED 11.

The communication IF unit 30 provides an interface between the processor 20 and the control plane 200. In other words, when receiving topology information that is advertised in the control plane 200, the communication IF unit 30 forwards the topology information to the topology information controller 22. When receiving a path calculation request from a node via the control plane 200, the communication IF unit 30 forwards the path calculation request to the path calculator 21. Furthermore, the communication IF unit 30 transmits a result of the calculation performed by the path calculator 21 to the node that has issued the path calculation request.

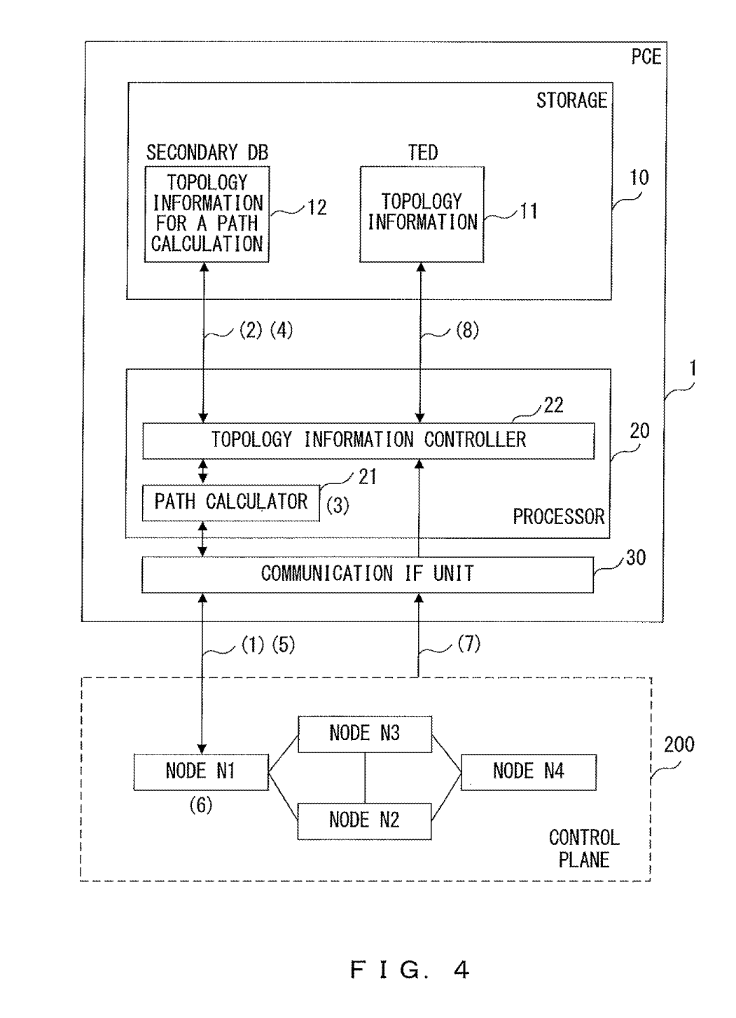

The path computation element PCE 1 having the above-mentioned configuration determines a path in response to a path calculation request received from a node via the control plane 200. A procedure for determining a path in response to a path calculation request will be described with reference to FIG. 4.

(1) The path calculator 21 receives a path calculation request from a node in the transmission network via the control plane 200. The path calculation request is generated, for example, when a user of the transmission network inputs a command for a path establishment to the node. Further, as described above, the path calculation request includes information that indicates a start point and an end point of a path established in the data plane, and also includes a constraint condition for the path. In the example of FIG. 4, a path calculation request is issued by node N1.

(2) and (3) The path calculator 21 reads topology information for a path calculation from the secondary database 12. Then, the path calculator 21 determines a path that satisfies a start point, an end point, and a constraint condition that are designated by the path calculation request by use of the topology information for a path calculation.

(4) The topology information controller 22 updates the secondary database 12 according to a result of a path calculation. As a result of this update, the topology information for a path calculation stored in the secondary database 12 indicates a state in which the path determined by the path calculator 21 is established in the transmission network. In other words, the processor 20 virtually establishes the path determined by the path calculation in the transmission network using the topology information for a path calculation. However, the control plane 200 has not yet performed a path establishment at this point. Thus, a topology indicated by the topology information database TED 11 does not match an actual topology of the transmission network. Further, the topology information stored in the topology information database TED does not match the topology information for a path calculation stored in the secondary database 12.

(5) The path calculator 21 transmits the result of the path calculation to the node that has issued the path calculation request. As described above, this result of the path calculation includes path information that indicates a route on which the path between the start point and the end point that have been designated in the path calculation request is established and a bandwidth of the path.

(6) The control plane 200 starts reserving a bandwidth for establishing a path according to the path information generated by the path calculator 21. As an example, a path message (path) is transmitted from a start-point node to an end-point node, and a reservation message (resv) is returned from the end-point node to the start-point node. These messages are transmitted via the route designated by the path information. Then, when bandwidths have been successfully reserved in the start-point node, the end-point node, and all nodes on the route, each of the nodes advertises, in the control plane 200, topology updating information that indicates a change in topology.

(7) and (8) The path computation element PCE 1 obtains the pieces of topology updating information that are advertised in the control plane 200. Then, the topology information controller 22 updates the topology information database TED using the newly obtained pieces of topology updating information. As a result, the topology information stored in the topology information database TED 11 indicates a topology of the transmission network in which a new path has been established.

As described above, the topology information stored in the secondary database 12 is updated when a path calculation has been performed by the path calculator 21. After that, when a path has actually been established by the control plane 200, the topology information stored in the topology information database TED 11 is updated. Here, when the path is successfully established by the control plane 200, the topology information stored in the topology information database TED 11 matches the topology information for a path calculation stored in the secondary database 12.

On the other hand, when the path establishment by the control plane 200 fails, the topology information stored in the topology information database TED 11 does not match the topology information for a path calculation stored in the secondary database 12. In this case, the topology information controller 22 forces an establishment of synchronization between the topology information database TED 11 and the secondary database 12. Specifically, the topology information controller 22 overwrites the secondary database 12 with the topology information stored in the topology information database TED 11. Note that the topology information controller 22 may periodically compare the topology information database TED 11 with the secondary database 12, and may force an establishment of synchronization when they do not match each other.

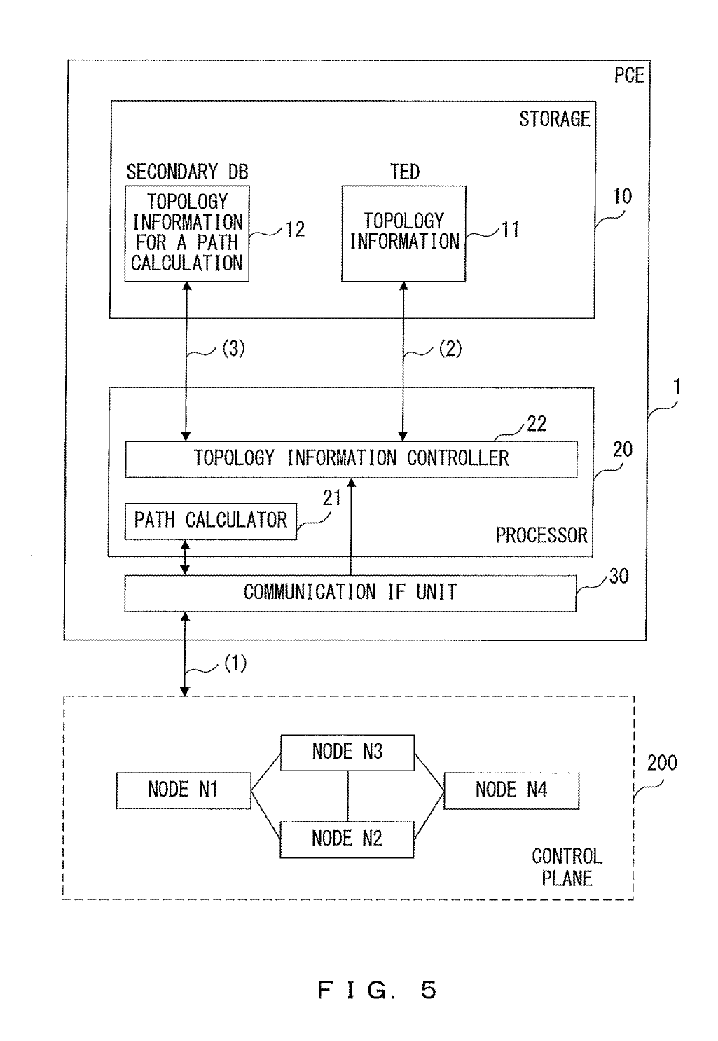

A procedure for updating the topology information database TED 11 is as illustrated in FIG. 5:

(1) The topology information controller 22 receives topology information that is advertised in the control plane 200.
(2) The topology information controller 22 updates the topology information database TED 11 using the received topology information.
(3) The topology information controller 22 establishes synchronization between the topology information database TED 11 and the secondary database 12. In other words, the topology information controller 22 reflects the updated contents of the topology information database TED 11 in the secondary database 12.

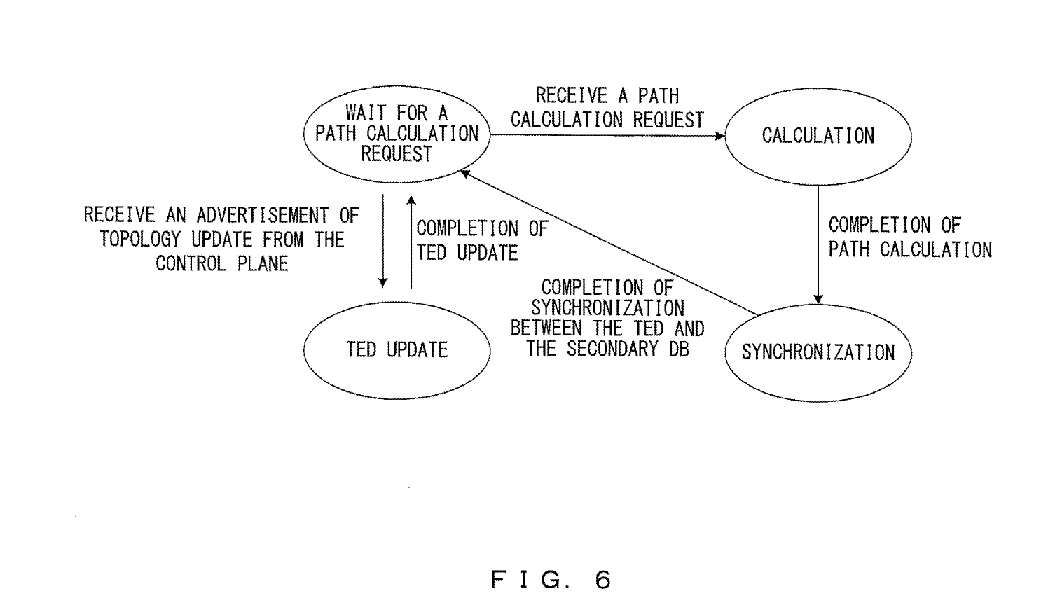

FIG. 6 illustrates a transition of an operation state of the path computation element PCE 1. As illustrated in FIG. 6, the path computation element PCE 1 operates in one of the four operation states. For example, when the path computation element PCE 1 receives an advertisement of topology information from the control plane 200 while “waiting for a path calculation request”, the operation state transitions from “wait for a path calculation request” to “TED update”. When a process of updating the topology information database TED 11 is completed, the operation state returns from “TED update” to “wait for a path calculation request”. When the path computation element PCE 1 receives a path calculation request while “waiting for a path calculation request”, the operation state transitions from “wait for a path calculation request” to “calculation”. When a path calculation is completed, the operation state transitions from “calculation” to “synchronization”. When a process of establishing synchronization between the topology information database TED 11 and the secondary database 12 is completed, the operation state returns from “synchronization” to “wait for a path calculation request”.

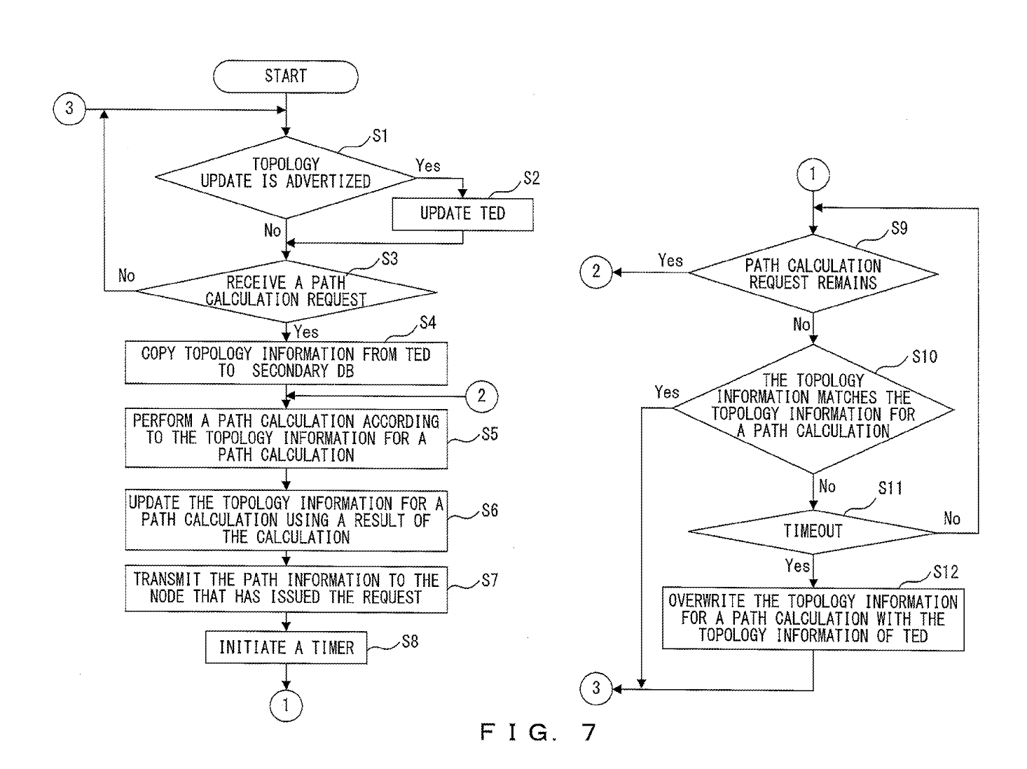

FIG. 7 is a flowchart that illustrates an operation of the path computation element PCE 1 according to the first embodiment. Processing in the flowchart is performed by the path calculator 21 and the topology information controller 22 in the processor 20. S1 and S2 are performed in a “TED update” state illustrated in FIG. 6. S3 is performed in a “wait for a path calculation request” state. S4-S9 are performed in a “calculation” state. S10-S12 are performed in a “synchronization” state.

In S1, the topology information controller 22 monitors whether topology updating information is advertised in the control plane 200. When a new path is established in the transmission network, or when a path established in the transmission network is released, a node that is involved in establishing/releasing the path advertises topology updating information in the control plane 200. Then, when the topology updating information is advertised in the control plane 200, in S2, the topology information controller 22 updates the topology information database TED 11 according to the content of the advertisement.

In S3, the path calculator 21 waits for a path calculation request. The path calculation request is issued by, for example, a start-point node of a new path. Then, when the path calculator 21 receives the path calculation request, the process of the processor 20 moves on to S4. On the other hand, when the path calculator 21 has not received the path calculation request, the process of the processor 20 returns to S1.

In S4, the topology information controller 22 obtains, in response to a request from the path calculator 21, topology information stored in the topology information database TED 11, and writes it in the secondary database 12. After that, the topology information that has been written in the secondary database 12 is used as topology information for a path calculation.

In S5, the path calculator 21 performs a path calculation in response to the received path calculation request according to the topology information for a path calculation stored in the secondary database 12. As a result, a path that satisfies the received path calculation request is determined. Then, the path calculator 21 generates path information that indicates a route on which the determined path is established and a bandwidth of the path.

In S6, the topology information controller 22 updates the secondary database 12 using the path information generated by the path calculator 21. In S7, the path calculator 21 transmits the path information to the node that has issued the path calculation request. The node that receives the path information starts a process of reserving a bandwidth according to the path information.

In S8, the processor 20 initiates a timer. The timer counts a specified timeout period. The specified timeout period is longer than, for example, a maximum reservable period of time prescribed for a sequence of bandwidth reservations in the control plane 200.

In S9, the processor 20 confirms whether there is a path calculation request left in a queue. In one embodiment, when the path computation element PCE 1 receives a plurality of path calculation requests, the processor 20 processes the plurality of path calculation requests sequentially one at a time. Thus, for example, when a plurality of path calculation requests have been issued at the same time or in a short period of time, the path calculation requests are stored in a queue. Then, when there is no longer a path calculation request left in a queue, the process of the processor 20 moves on to S10. On the other hand, when there is a path calculation request left in the queue, the process of the processor 20 returns to S5. In this case, a path calculation is performed for a path calculation request stored at the beginning of the queue.

In S10 and S11, the topology information controller 22 monitors whether the topology information stored in the topology information database TED 11 matches the topology information for a path calculation stored in the secondary database 12. Here, when receiving an advertisement that indicates a topology update from the control plane 200, the topology information controller 22 updates the topology information database TED 11 according to the content of the advertisement. The process of updating the topology information database TED 11 according to the advertisement in the control plane 200 may be performed in parallel with the processing of the flowchart illustrated in FIG. 7.

When a state in which the topology information matches the topology information for a path calculation has been obtained before the timer that has been initiated in S8 expires (S10: Yes), the process of the processor 20 returns to S1. In this case, the topology information controller 22 does not have to update the secondary database 12. On the other hand, when the timer has expired before the topology information matches the topology information for a path calculation (S11: Yes), the topology information controller 22 establishes synchronization between the topology information database TED 11 and the secondary database 12. In other words, the secondary database 12 is overwritten with the topology information stored in the topology information database TED 11. After that, the process of the processor 20 returns to S1. When the path computation element PCE 1 receives a new path calculation request before the timer expires (S9: Yes), the process of the processor 20 returns to S5.

In the flowchart of FIG. 7, when the path computation element PCE 1 receives a plurality of path calculation requests at the same time or in a short period of time, the processes of S5-S9 are repeatedly performed. In this case, the path calculator 21 performs a path calculation using the topology information for a path calculation stored in the secondary database 12. Here, the topology information for a path calculation is updated every time a path calculation corresponding to each path calculation request is performed. Thus, the path computation element PCE 1 can determine an appropriate path for a new path calculation request while considering a result of a previously performed path calculation even before a bandwidth reservation is completed in the control plane 200.

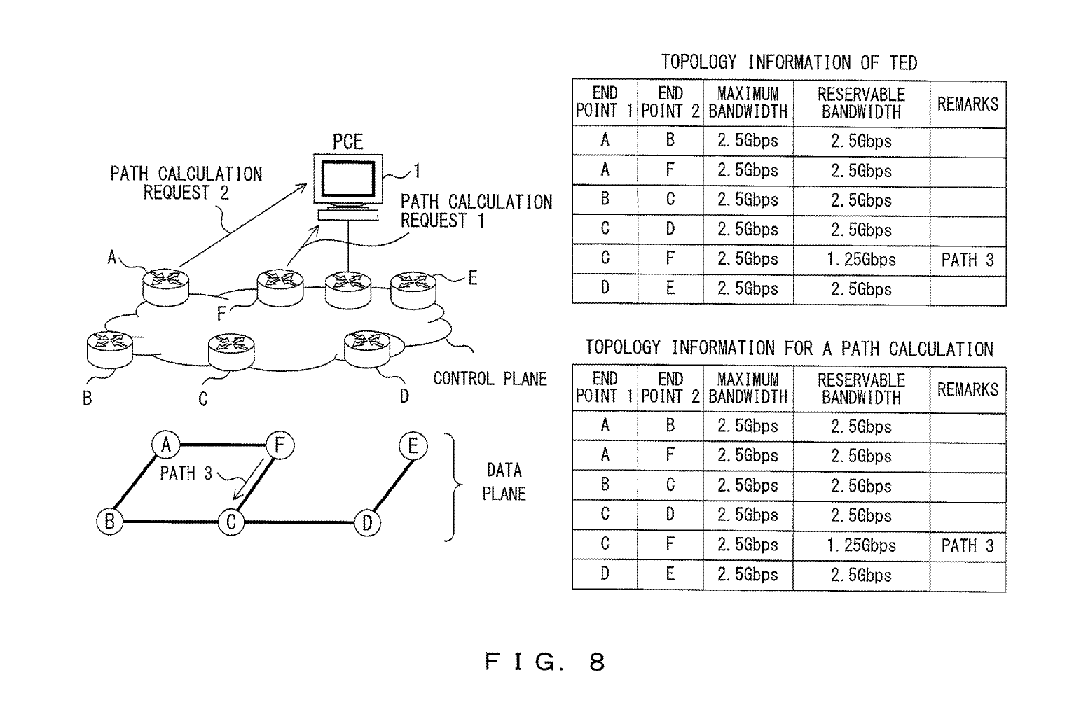

FIGS. 8-11 illustrate examples of operations of the path computation element PCE 1 according to the first embodiment. In this embodiment, the transmission network includes nodes A to F. The control plane is separated from the data plane. In the data plane, links are respectively provided between the nodes A and B, the nodes A and F, the nodes B and C, the nodes C and D, the nodes C and F, and the nodes D and E. Each of the links is implemented by, for example, an optical fiber line. A bandwidth of each of the links is 2.5 Gbps. In the following descriptions, a link that is identified by a set of an endpoint X and an end point Y may be referred to as “link XY”.

The topology information database TED 11 stores therein topology information that indicates a state of the transmission network. An “end point 1” and an “end point 2” identify nodes at both ends of a link. A “maximum bandwidth” indicates a maximum bandwidth that can be provided by each link. A “reservable bandwidth” indicates an unused bandwidth (that is, a bandwidth that can be allocated to a new path request).

Here, as illustrated in FIG. 8, it is assumed that a path 3 that transmits a signal of 1.25 Gbps has been established from the node F to the node C. In this case, the topology information stored in the topology information database TED 11 is updated when the path 3 has been established in the transmission network. Specifically, a reservable bandwidth of a link CF has been updated from “2.5 Gbps” to “1.25 Gbps”. Further, information indicating that the path 3 is established on the link CF is registered.

The topology information for a path calculation stored in the secondary database 12 is updated according to a result of a path calculation. However, it is assumed that, when the operation according to this embodiment starts, the topology information for a path calculation stored in the secondary database 12 matches the topology information stored in the topology information database TED 11, as illustrated in FIG. 8.

It is assumed that a plurality of path calculation requests are issued at the same time or in a short period of time. In this embodiment, a path calculation request 1 and a path calculation request 2 below are respectively issued by the node F and the node A almost at the same time.

Path calculation request 1: start point=F, end point=D, bandwidth=1.25 Gbps
Path calculation request 2: start point=A, end point=D, bandwidth=1.25 Gbps
Then, the path computation element PCE 1 receives the path calculation request 1 and the path calculation request 2. Note that when a link failure has occurred in the data plane, a plurality of path calculation requests may be issued almost at the same time. In addition, when congestion has occurred in a specified node due to an increase in traffic, a plurality of path calculation requests may be issued almost at the same time.

The path computation element PCE 1 performs a path calculation in response to the received path calculation request. In this embodiment, the path computation element PCE performs a path calculation in response to the path calculation request 1 first. In this case, the path calculation request 2 is stored in a queue that is provided in the processor 20.

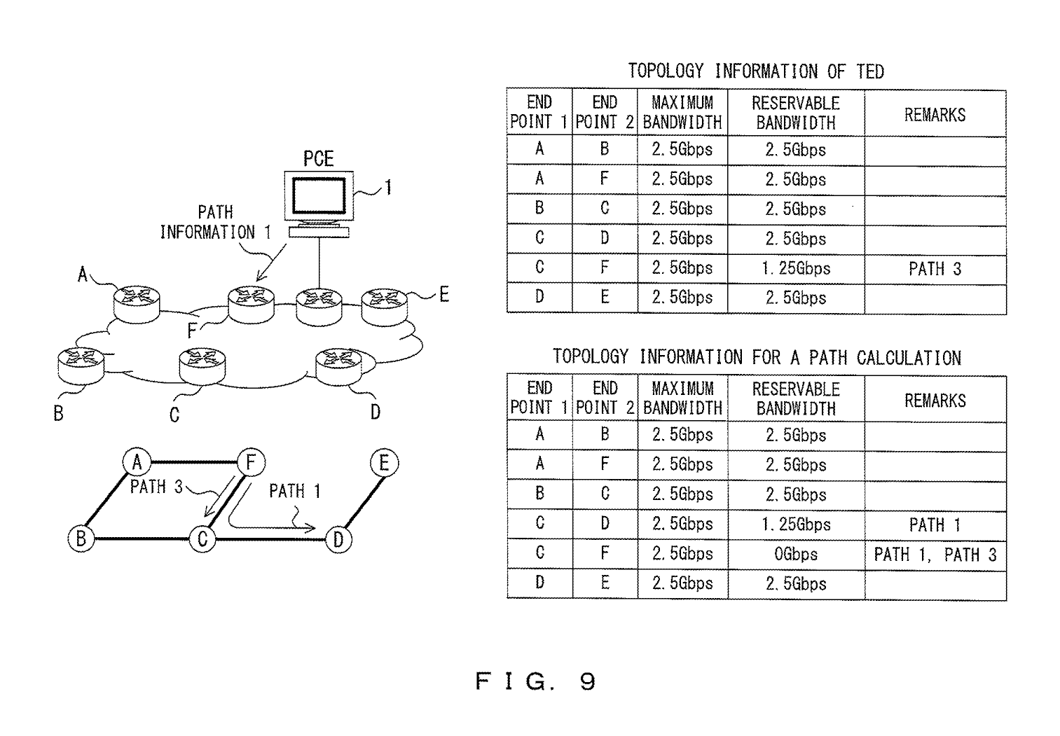

The path calculator 21 performs a path calculation using the topology information for a path calculation stored in the secondary database 12, and determines a path that satisfies the path calculation request 1. In this example, a path 1 “F→C→D” is determined in response to the path calculation request 1. Then, the topology information controller 22 updates the topology information for a path calculation so that the topology information for a path calculation indicates a state in which the path 1 has been established in the transmission network. Specifically, the bandwidth of the path 1 is subtracted from each of the reservable bandwidths of a link CD and the link CF on which the path 1 is established. As a result, the reservable bandwidth of the link CD is updated from “2.5 Gbps” to “1.25 Gbps”, and the reservable bandwidth of the link CF is updated from “1.25 Gbps” to “zero” in the topology information for a path calculation, as illustrated in FIG. 9. Here, the topology information for a path calculation indicates a state in which the path 1 has been established in the transmission network.

However, at this point, the path 1 has not been established in the transmission network. Thus, at this point, the topology information stored in the topology information database TED 11 indicates a state in which the path 1 is not established.

After that, the processor 20 transmits, to the node F, path information 1 that indicates a result of the calculation in response to the path calculation request 1. Here, the processor 20 initiates the timer in S8 of FIG. 7. In other words, a guard time period starts.

The node F starts a process of reserving a bandwidth of the path 1 according to the path information 1 received from the path computation element PCE 1. As a result, bandwidths for establishing the path 1 are reserved on the link CD and the link CF. Then, when the bandwidths have been successfully reserved, the node F (or each of the nodes F, C, and D) advertises topology updating information in the control plane. In other words, topology updating information indicating that the path 1 has been newly established is advertised in the control plane.

Next, the path calculator 21 performs a path calculation using the topology information for a path calculation stored in the secondary database 12, and determines a path that satisfies the path calculation request 2. At this point, the topology information for a path calculation has been updated to the state illustrated in FIG. 9. In other words, according to the topology information for a path calculation, the reservable bandwidth of the link CF is “zero”. Thus, the path calculator 21 determines a path that satisfies the path calculation request 2 without using the link CF.

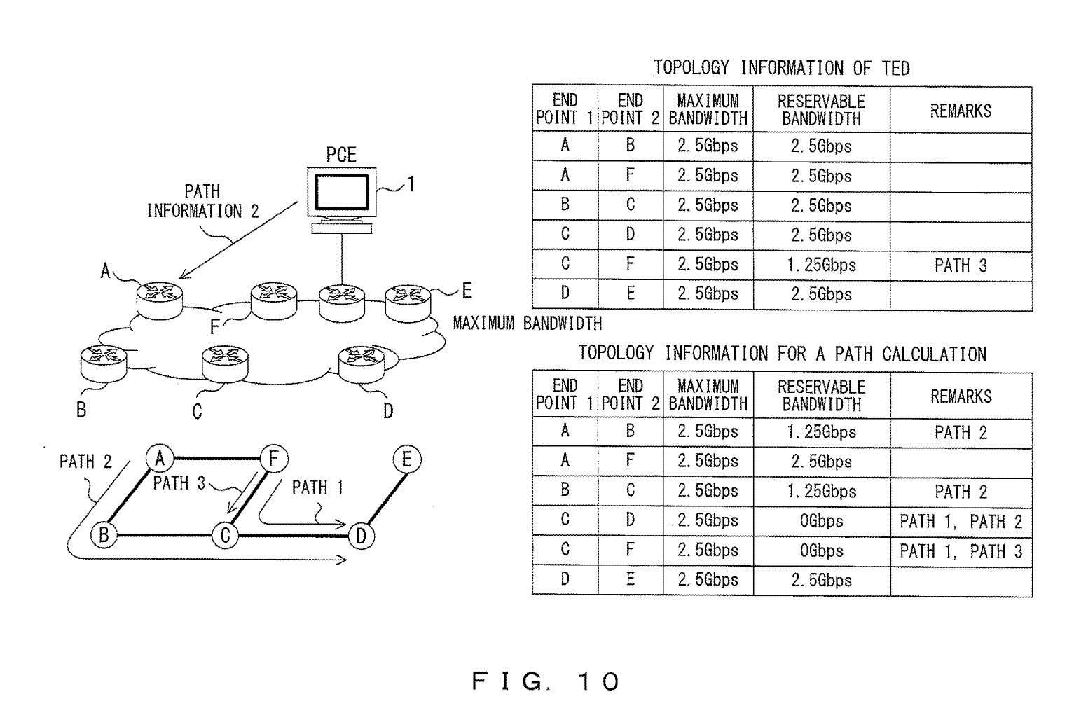

In this example, a path 2 “A→B→C→D” is determined for the path calculation request 2. Then, the topology information controller 22 updates the topology information for a path calculation so that the topology information for a path calculation indicates a state in which the path 2 has been established in the transmission network. In other words, the bandwidth of the path 2 is subtracted from each of the reservable bandwidths of a link AB, a link BC, and the link CD on which the path 2 is established. Specifically, the reservable bandwidth of the link AB is updated from “2.5 Gbps” to “1.25 Gbps”, the reservable bandwidth of the link BC is updated from “2.5 Gbps” to “1.25 Gbps”, and the reservable bandwidth of the link CD is updated from “1.25 Gbps” to “zero” in the topology information for a path calculation, as illustrated in FIG. 10. As a result, the topology information for a path calculation indicates a state in which the path 1 and the path 2 have been established in the data plane.

However, at this point, the path 1 and the path 2 have not been established in the transmission network. Thus, at this point, the topology information stored in the topology information database TED 11 indicates a state in which the path 1 and the path 2 are not established.

After that, the processor 20 transmits, to the node A, path information 2 that indicates a result of the calculation in response to the path calculation request 2. Here, the processor 20 initiates the timer illustrated in S8 of FIG. 7. In other words, a guard time period starts again.

The node A starts a process of reserving a bandwidth of the path 2 according to the path information 2 received from the path computation element PCE 1. As a result, bandwidths for establishing the path 2 are reserved on the link AB, the link BC, and the link CD. Then, when the bandwidths have been successfully reserved, the node A (or each of the nodes A, B, C, and D) advertises, in the control plane, information that indicates topology update. In other words, topology updating information indicating that the path 2 has been newly established is advertised in the control plane.

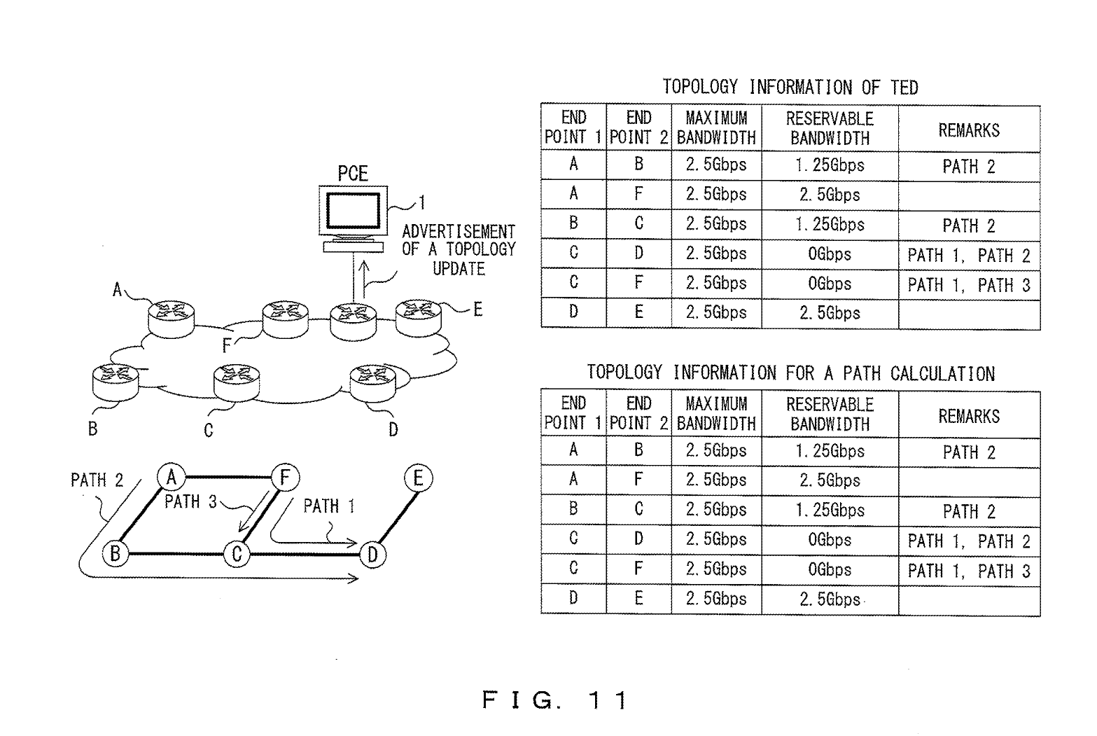

The path computation element PCE 1 obtains the topology updating information that is advertised in the control plane. In other words, the path computation element PCE 1 obtains an advertisement that indicates a topology update (the establishment of the path 1 and the path 2). Then, the topology information controller 22 updates the topology information database TED 11 according to the topology updating information, as illustrated in FIG. 11. As a result, the topology information stored in the topology information database TED 11 matches the topology information for a path calculation stored in the secondary database 12.

As illustrated in S10 and S11 of FIG. 7, when the topology information stored in the topology information database TED 11 does not match the topology information for a path calculation stored in the secondary database 12 upon the expiry of the timer, the topology information controller 22 forces an establishment of synchronization between the topology information database TED 11 and the secondary database 12. In other words, the secondary database 12 is overwritten with the topology information stored in the topology information database TED 11.

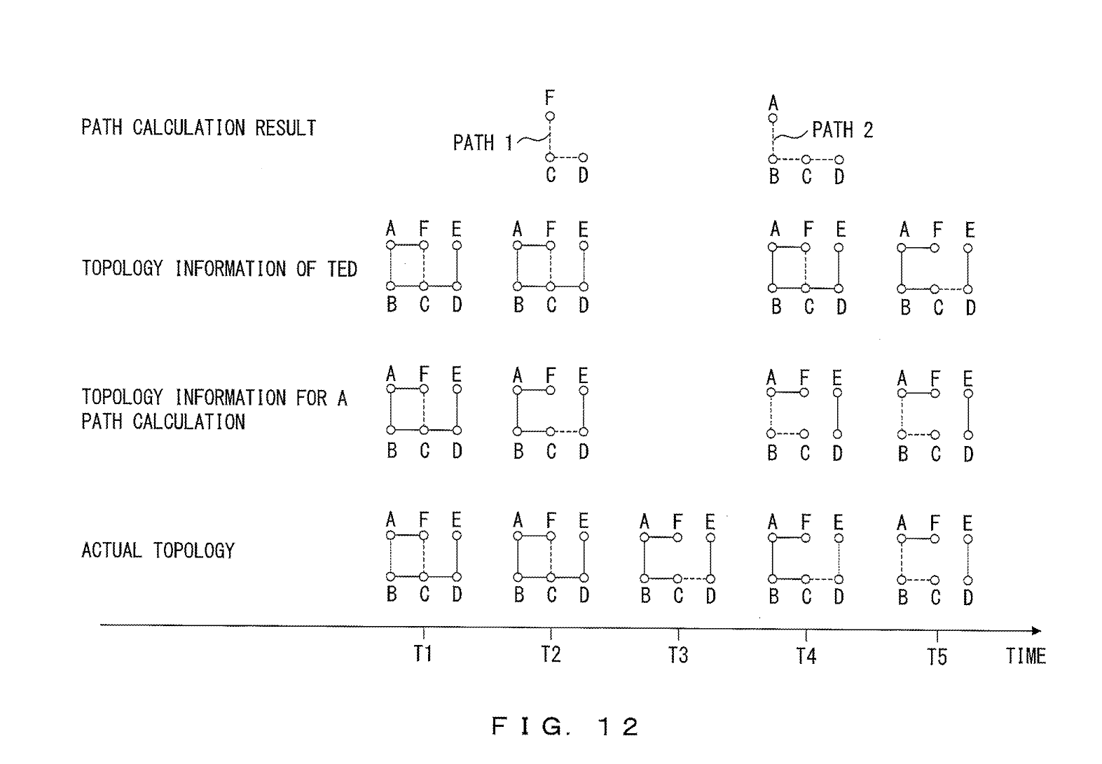

FIG. 12 is a time chart of the path establishment illustrated in FIGS. 8-11. In FIG. 12, a solid line represents a link whose reservable bandwidth is 2.5 Gbps. A dashed line represents a link whose reservable bandwidth is 1.25 Gbps.

At a time T1, an actual topology, the topology information stored in the topology information database TED 11, and the topology information for a path calculation stored in the secondary database 12 match. Then, the path computation element PCE 1 receives the path calculation request 1 and the path calculation request 2.

During a period between the time T1 and a time T2, the path calculator 21 determines the path 1 that satisfies the path calculation request 1 using the topology information for a path calculation. Then, at the time T2, the topology information controller 22 updates the topology information for a path calculation according to a result of the calculation for the path calculation request 1. In other words, the topology information for a path calculation indicates a topology in which the path 1 has been established in the transmission network. Further, the path information 1 that indicates the result of the calculation for the path calculation request 1 is reported to the node F.

The node F starts reserving a bandwidth according to the received path information 1. Then, at a time T3, the reservation of a bandwidth corresponding to the path information 1 is completed. However, at this point, the path computation element PCE 1 has not received an advertisement that indicates the establishment of the path 1. Thus, the topology information stored in the topology information database TED 11 has not been updated yet.

During a period from the time T2 to a time T4, the path calculator 21 determines the path 2 that satisfies the path calculation request 2 using the topology information for a path calculation. Here, the topology information for a path calculation indicates a topology in which the path 1 has been established. In other words, the path calculator 21 can perform a path calculation for the path calculation request 2 assuming that the establishment of the path 1 has been successful. Then, at the time T4, the topology information controller 22 updates the topology information for a path calculation according to a result of the calculation for the path calculation request 2. In other words, the topology information for a path calculation indicates a topology in which the path 1 and the path 2 have been established. Further, the path information 2 that indicates the result of the calculation for the path calculation request 2 is reported to the node A.

The node A starts reserving a bandwidth according to the received path information 2. Then, at a time T5, the reservation of a bandwidth corresponding to the path information 2 is completed. Then, the topology information stored in the topology information database TED 11 is updated by an advertisement indicating that the bandwidth of the path 1 has been successfully reserved. After that, the topology information is further updated by an advertisement indicating that the bandwidth of the path 2 has been successfully reserved, though this is not illustrated.

As described above, in the first embodiment, the path computation element PCE 1 performs a path calculation using the topology information for a path calculation stored in the secondary database 12, not using the topology information stored in the topology information database TED 11. Here, the topology information stored in the topology information database TED 11 is updated according to information advertised in the control plane after a bandwidth reservation is actually completed in the transmission network. Thus, when a plurality of path calculation requests are issued in a short period of time, the next path calculation may be performed without considering a result of a previously performed path calculation, thus, there is a possibility that an appropriate path is not obtained. On the other hand, when it comes to the topology information for a path calculation stored in the secondary database 12, the next path calculation is performed in consideration of a result of a previously performed path calculation without waiting for a bandwidth reservation to be actually completed. Thus, a path calculation method according to the first embodiment permits an appropriate path establishment. As a result, the first embodiment can resolves a problem of the conventional art (for example, a state in which an excessive amount of bandwidth is allocated to a certain link).

In addition to this, when a plurality of paths have to be established (for example, the occurrence of a failure, and switching of network), a path whose bandwidth is guaranteed can be appropriately determined. Thus, a bandwidth reservation is less likely to fail in the transmission network, which results in reducing the working time needed for establishing a path.

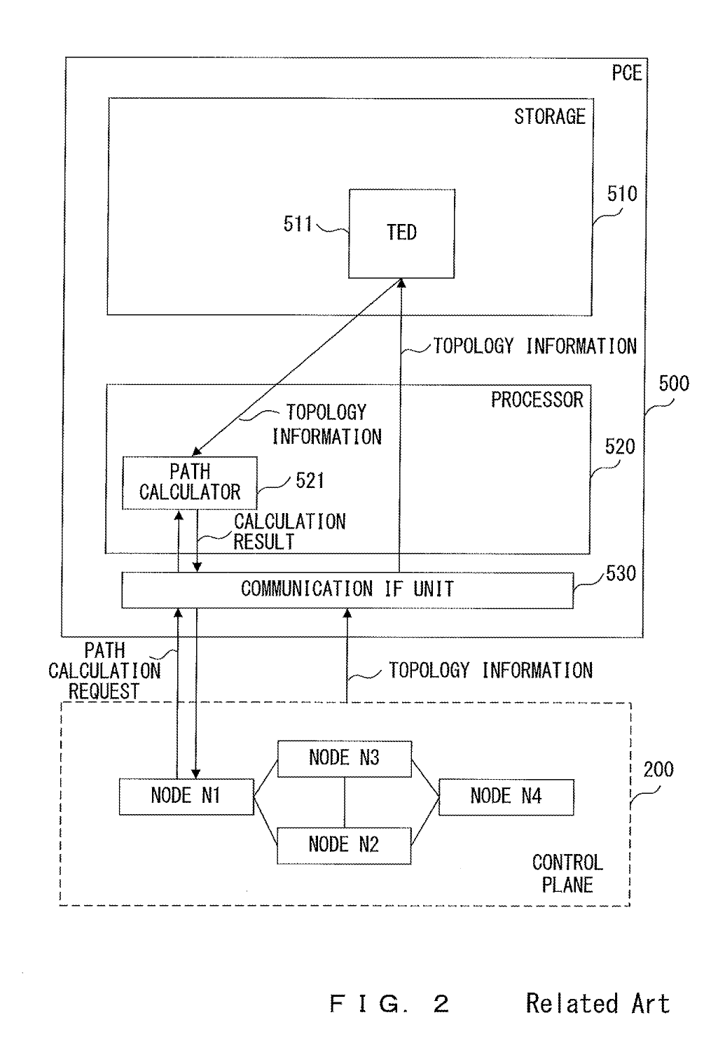

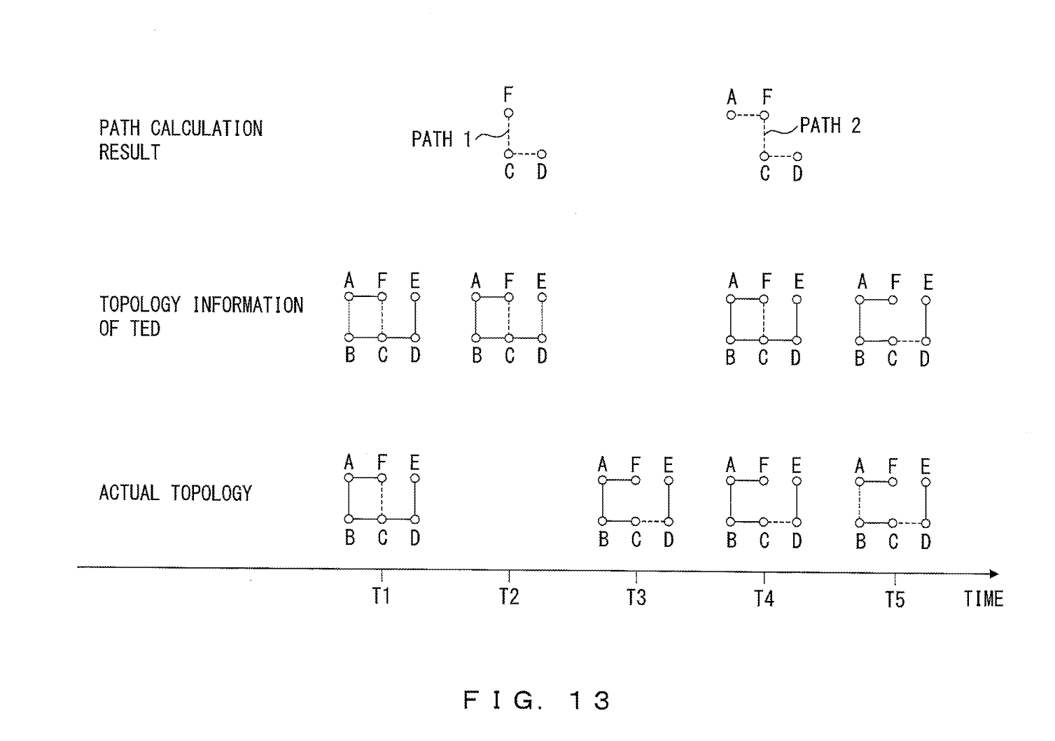

FIG. 13 is a time chart that illustrates a case in which a path calculation is performed without using the topology information for a path calculation. This processing is performed by, for example, the PCE 500 illustrated in FIG. 2. In this case, the path calculator 521 performs a path calculation using the topology information stored in the topology information database TED 511. In other words, during a period from the time T2 to the time T4, the path calculator 521 performs a path calculation for the path calculation request 2 using the topology information illustrated in FIG. 13. However, the path 1 is not reflected in the topology information during the period from the time T2 to the time T4. For example, in the topology information at this point, the reservable bandwidth of the link CF is 1.25 Gbps. In other words, the path calculator 521 does not exclude the link CF when determining a path for the path calculation request 2.

In the example illustrated in FIG. 13, the path 2 “A→F→C→D” is obtained for the path calculation request 2. However, on the link CF, the path 3 has been already established, and further, the path 1 has been allocated. Thus, the bandwidth of the path 2 will not be successfully reserved. In this case, the node A issues a path calculation request again. Then, the PCE 500 performs a path calculation for the newly issued path calculation request. In other words, compared to the path calculation method according to the first embodiment, it takes longer time until an appropriate path is determined.

### Second Embodiment

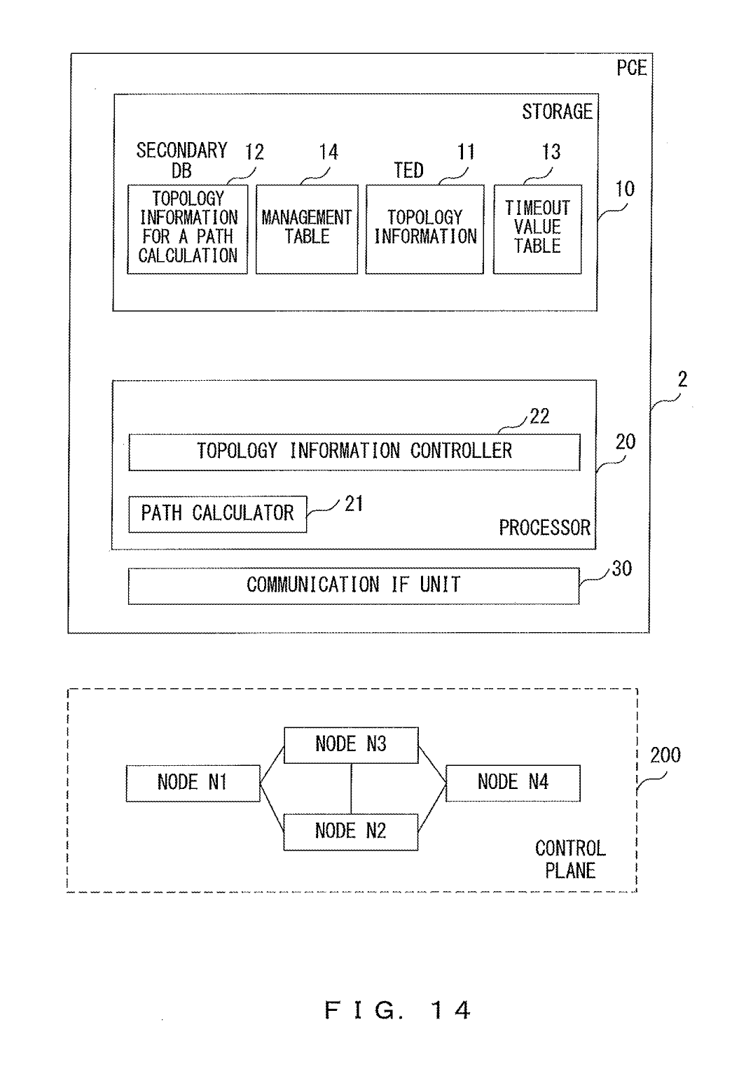

FIG. 14 illustrates an example of a configuration of a path calculation device according to a second embodiment of the present invention. Like the path computation element PCE 1 of the first embodiment, a path computation element PCE 2 of the second embodiment includes a storage 10, a processor 20, and a communication IF unit 30. However, the storage 10 of the second embodiment includes a timeout value table 13 and a management table 14 in addition to the topology information database TED 11 and the secondary database 12.

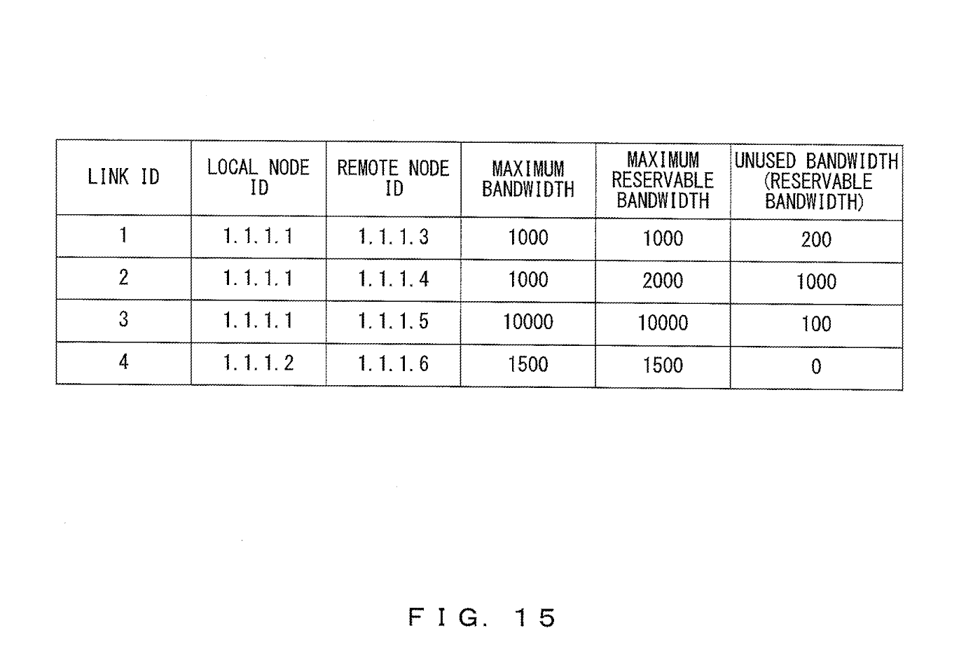

The configurations of the topology information database TED 11 and the secondary database 12 in the second embodiment are substantially similar to those in the first embodiment. Further, the configurations of the topology information database TED 11 and the secondary database 12 are substantially similar to each other. FIG. 15 illustrates an example of a configuration of the topology information database TED 11 or a configuration of the secondary database 12.

A link ID identifies each link in a transmission network. A local node ID identifies one of the nodes located at both ends of a corresponding link. A remote node ID identifies another node located at another end of the corresponding link. The local node ID and the remote node ID may be, for example, an IP address of the corresponding node. A maximum bandwidth indicates an available bandwidth on the corresponding link. A maximum reservable bandwidth indicates a bandwidth that can be used on the corresponding link. An unused bandwidth (a reservable bandwidth) indicates an unreserved bandwidth on the corresponding link.

The timeout value table 13 stores therein a timeout value that corresponds to each node in the transmission network. In this example, a timeout value is determined based on a timeout value allowed for a sequence of bandwidth reservations for establishing a path. For example, a start-point node transmits a path message (path) to an end-point node. Then, the end-point node that has received the path message returns a reservation message (resv) to the start-point node. Here, the start-point node determines that a bandwidth has not been successfully reserved when it does not receive the reservation message within a specified timeout period. A timeout value to be registered in the timeout value table 13 is determined based on the above-mentioned timeout value for a sequence of bandwidth reservations. The timeout value to be registered in the timeout value table 13 is not less than the timeout value for a sequence of bandwidth reservations. As an example, the timeout value to be registered in the timeout value table 13 is five times the timeout value for a sequence of bandwidth reservations. However, the timeout value for a sequence of bandwidth reservations itself may be stored in the timeout value table 13.

The management table 14 manages a difference between the topology information database TED 11 and the secondary database 12. Here, as is the case with the first embodiment, the path computation element PCE 2 determines a path that satisfies the received path calculation request, and transmits, to the node that has issued the path calculation request, path information that indicates the determined path. Then, the secondary database 12 is updated when the path is determined by the path calculator 21 before a path establishment is actually performed in the transmission network. After that, when the path is established in the transmission network, the topology information database TED 11 is updated according to the path establishment. In other words, during a period of time from the path calculation was performed until the path establishment is actually performed in the transmission network, the topology information stored in the topology information database TED 11 and the topology information for a path calculation stored in the secondary database 12 are different from each other. Thus, the management table 14 manages the difference between the topology information database TED 11 and the secondary database 12 (or a difference between an actual topology and a topology indicated by topology information for a path calculation).

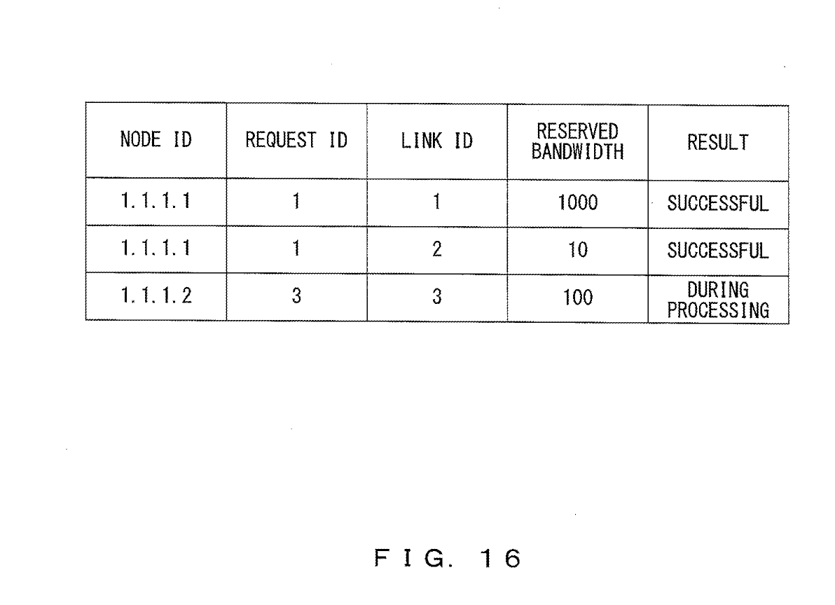

FIG. 16 illustrates an example of the management table 14. A node ID identifies a node that has issued a path calculation request. The node ID may be, for example, an IP address of a node. A request ID identifies a path calculation request. A link ID identifies a link on a route of a path that satisfies a path calculation request. In the example of FIG. 15, two links are specified for the path calculation request 1. A reserved bandwidth indicates a bandwidth reserved by a path calculation in response to a path calculation request. A result indicates a result of a path establishment in the transmission network (successful, unsuccessful, and during processing).

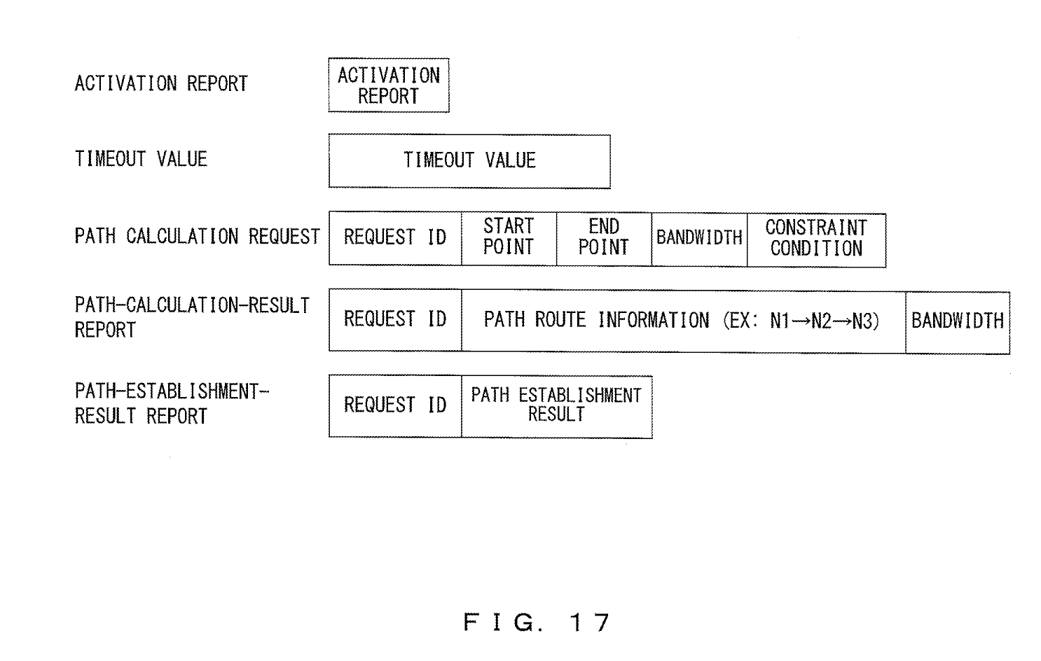

FIG. 17 illustrates an example of messages used between the path computation element PCE 2 and a node on the control plane. Each message includes a source address and a destination address, though this is not illustrated.

An activation reporting message includes information that reports to the PCE 2 that a source node has been activated. A timeout value message includes information that indicates a timeout value of a node. A path-calculation-request message includes a request ID, a start point, an end point, a bandwidth, and a constraint condition. The start point and the end point respectively indicate a start-point node and an end-point node of a path to be established. The bandwidth indicates a bandwidth of a path to be established. The constraint condition indicates a condition needed for the path to be established.

A path-calculation-result reporting message includes a request ID, path route information, and a bandwidth. The path route information indicates a route from a start-point node to an end-point node. The bandwidth indicates an allowed bandwidth. A path-establishment-result reporting message includes the request ID and a path establishment result. The path establishment result indicates whether a bandwidth has been successfully reserved in the transmission network.

In the second embodiment, the path computation element PCE 2 performs the following processes:

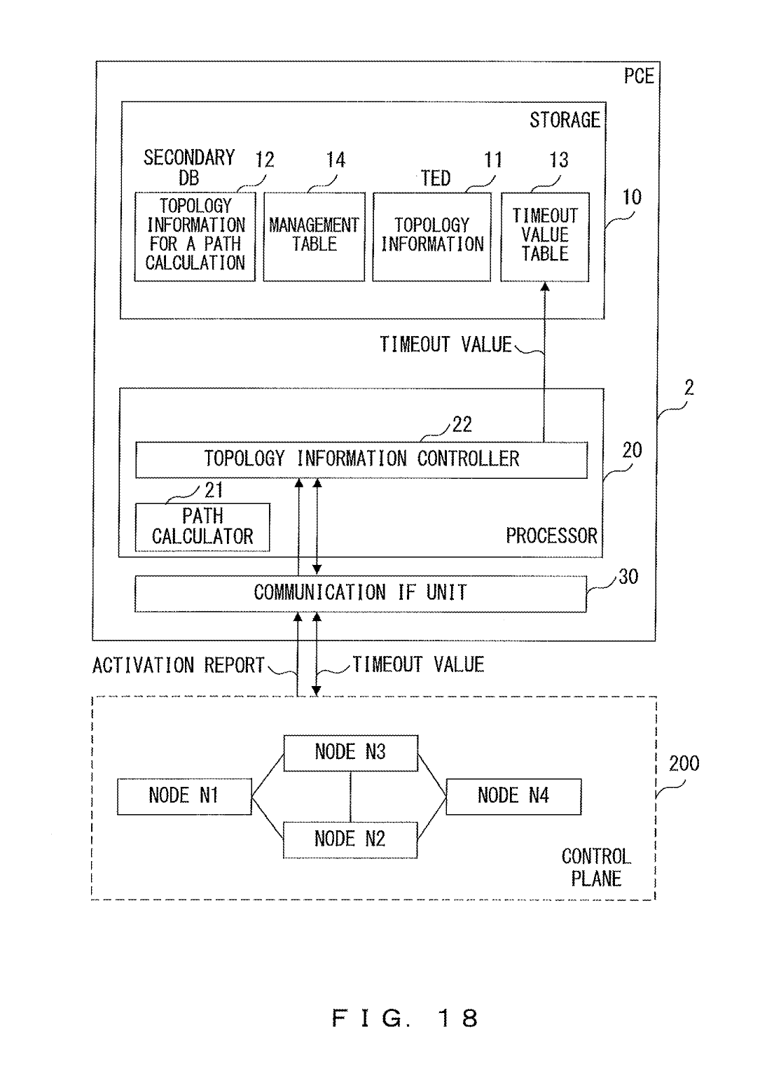

(1) Setting a timeout value
(2) Performing a path calculation
(3) Synchronization between the topology information database TED 11 and the secondary database 12
(4) Update of the topology information database TED 11 Each of the processes (1) to (4) will be described with reference to FIGS. 18-21.

FIG. 18 illustrates a process of establishing a timeout value. When the path computation element PCE 2 starts, the topology information controller 22 acquires a timeout value from each node in the transmission network via the communication IF unit 30. It is assumed that a timeout value for a sequence of bandwidth reservations is set in advance to each of the nodes. Then, the topology information controller 22 generates, from the timeout value acquired from each of the nodes, a timeout value used by the processor 20, and registers it in the timeout value table 13.

After that, when a new node is activated in the transmission network, the node transmits an activation reporting message to the path computation element PCE 2. The topology information controller 22 obtains a timeout value from the node via the communication IF unit 30. Then, the topology information controller 22 generates, from the obtained timeout value, a timeout value used by the processor 20, and registers it in the timeout value table 13.

When timeout values of all nodes in the transmission network are identical and known, the topology information controller 22 does not have to acquire the timeout value from each node. In this case, a timeout value is given to the path computation element PCE 2 by a network administrator. Alternatively, the timeout value used by the processor 20 may be set regardless of a timeout value of each node.

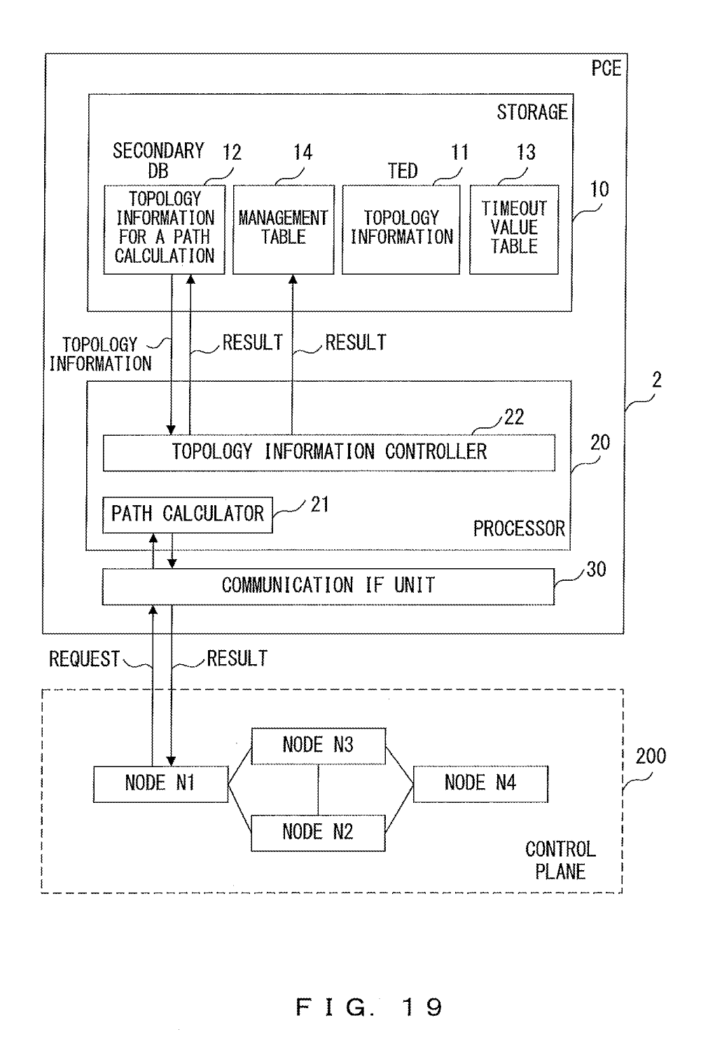

FIG. 19 illustrates a path calculation process. In the example illustrated in FIG. 19, a path calculation request is issued in the node N1. The path calculator 21 receives the path calculation request via the communication IF unit 30. Next, the path calculator 21 obtains the topology information for a path calculation from the secondary database 12. Then, the path calculator 21 performs a path calculation using the topology information for a path calculation and determines a path that satisfies the received path calculation request.

The topology information controller 22 updates the topology information for a path calculation by writing, in the secondary database 12, a result of the path calculation performed by the path calculator 21. Further, the topology information controller 22 registers the result of the path calculation performed by the path calculator 21 in the management table 14. Thus, as needed, the topology information controller 22 can restore the topology information for a path calculation to a state before updated, by referring to the management table 14.

Here, it is assumed that, when the path calculator receives the path calculation request, the topology information stored in the topology information database TED is identical to the topology information for a path calculation stored in the secondary database 12. In this case, information registered in the management table 14 (that is, a result of a path calculation) indicates a difference between the topology information database TED 11 and the secondary database 12. Thus, even after the topology information for a path calculation has been updated, the topology information controller 22 can make the content of the secondary database 12 identical to the content of the topology information database TED 11 by referring to the management table 14.

After that, the path calculator 21 transmits, via the communication IF unit 30, a path-calculation-result reporting message illustrated in FIG. 17 to the node that has issued the path calculation request. The node that receives the path-calculation-result reporting message starts a process of reserving a bandwidth according to path information.

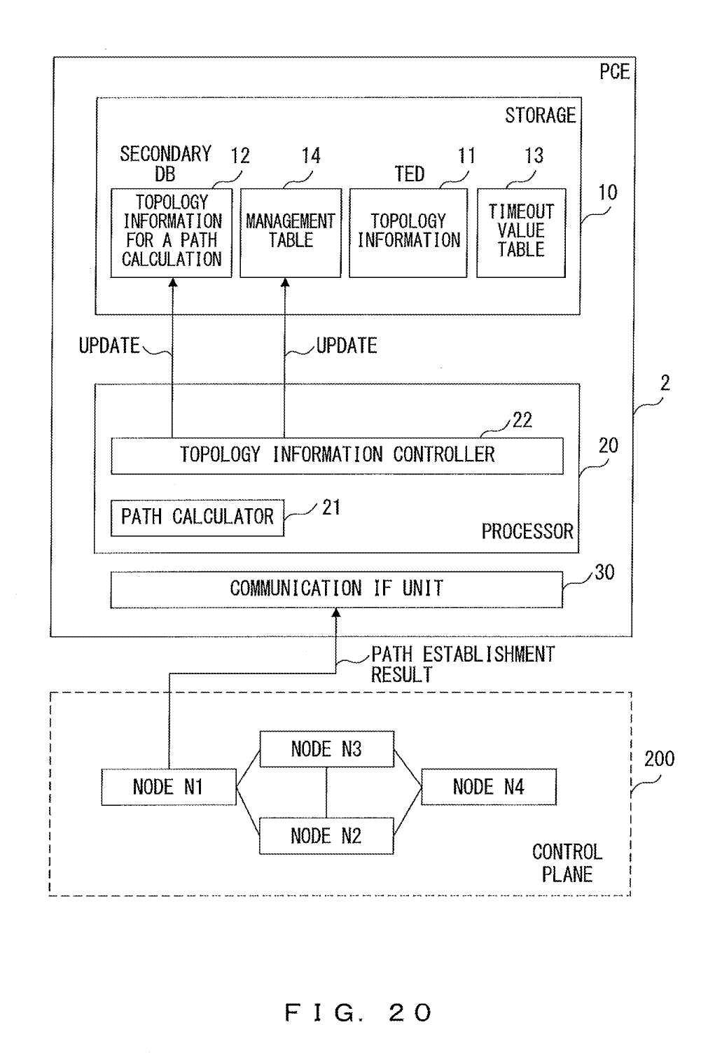

FIG. 20 illustrates a process of establishing synchronization between the topology information database TED 11 and the secondary database 12. The node that has issued the path calculation request performs a path establishment according to the path information generated by the path computation element PCE 2. Then, the node transmits, to the path computation element PCE 2, a path-establishment-result reporting message that is illustrated in FIG. 17 and that indicates a result of the path establishment (successful or unsuccessful).

The topology information controller 22 updates the secondary database 12 and the management table 14 according to the path-establishment-result reporting message received from the node. Specifically, when a path establishment has been successful in the transmission network (in other words, when a path-establishment-result reporting message that indicates a success of a path establishment is received), the topology information controller 22 deletes the information registered in the management table 14. Here, information that corresponds to a request ID stored in the path-establishment-result reporting message is deleted. When a path establishment has been successful in the transmission network, a topology of the transmission network matches the state registered in the secondary database 12. Thus, when a path establishment has been successful, the topology information controller 22 does not have to update the secondary database 12.

On the other hand, when a path establishment has failed in the transmission network (in other words, when a path-establishment-result reporting message that indicates a failure of a path establishment is received), the topology information controller 22 updates the secondary database 12. Here, the topology information controller 22 refers to the management table 14, and restores the topology information for a path calculation stored in the secondary database 12 to a state before a path calculation is performed. After that, the topology information controller 22 deletes information registered in the management table 14. When a period of time that has elapsed since a result of the path calculation was reported to the node exceeds a corresponding timeout value before the topology information controller 22 receives the path-establishment-result reporting message, the topology information controller 22 decides that the path establishment has failed. In this case, similar to when receiving the path-establishment-result reporting message that indicates the failure of the path establishment, the topology information controller 22 updates the secondary database 12.

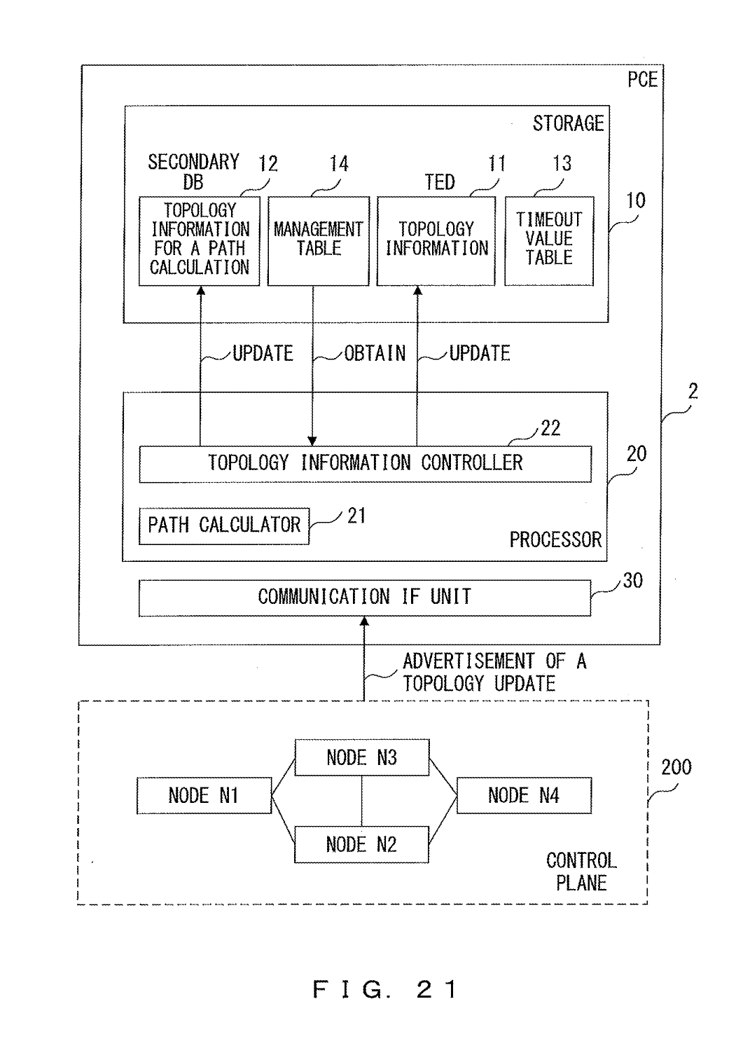

FIG. 21 illustrates a process of updating the topology information database TED 11. The topology information controller 22 receives an advertisement that indicates a topology update of a network from the control plane. Note that when the topology update of a network is updated due to, for example, establishment/release of a path, the topology update is advertised in the control plane.

Then, the topology information controller 22 updates the topology information database TED 11 according to the received advertisement. Further, the topology information controller 22 overwrites information stored in the secondary database 12 with topology information stored in the updated topology information database TED 11. In other words, a synchronizing process is performed. After that, the topology information controller 22 updates the secondary database 12 using the information stored in the management table 14.

A transition of an operation state of the path computation element PCE 2 is substantially similar to that of the first embodiment. In other words, the operation state of the path computation element PCE 2 transits between “wait for a path calculation request”, “TED update”, “wait for a path calculation request”, and “calculation”, as illustrated in FIG. 6.

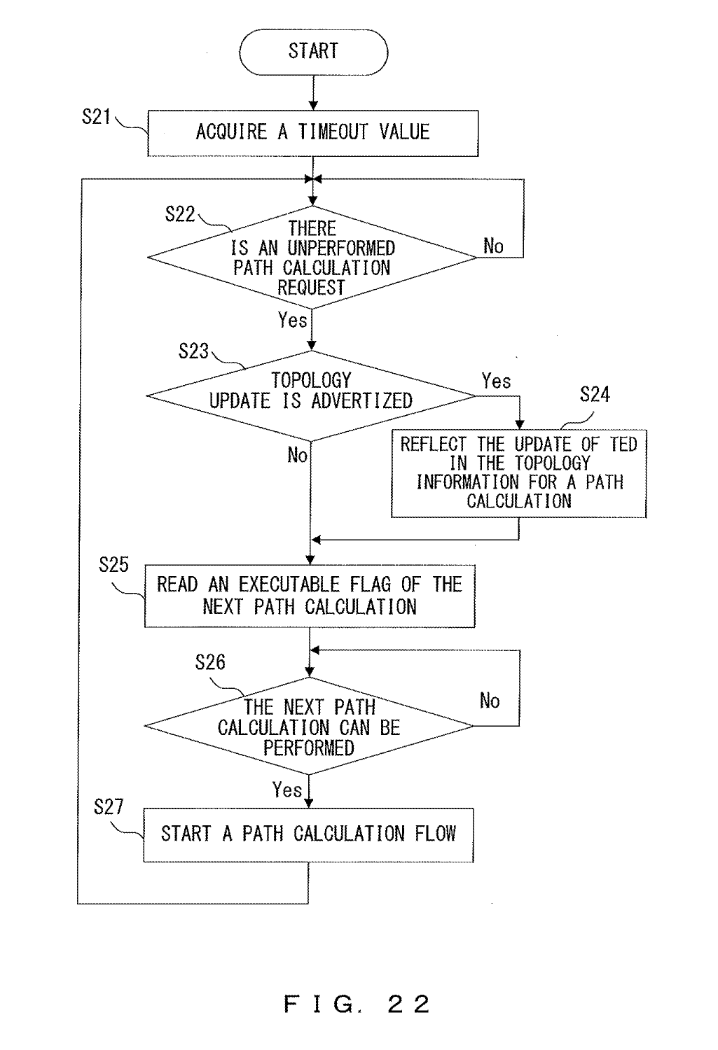

FIG. 22 is a flowchart that illustrates an operation of the path computation element PCE 2 according to the second embodiment. Processing in the flowchart is performed by the path calculator 21 and the topology information controller 22 in the processor 20. S22 is performed in a “wait for a path calculation request” state. S23 and S24 are performed in a “TED update” state. S25-S27 are performed in a “calculation” state or in a “synchronization” state.

In S21, the topology information controller 22 acquires a timeout value from each node in the transmission network. Then, the topology information controller 22 generates, from each of the acquired timeout values, a timeout value used by the processor 20, and registers it in the timeout value table 13.

In S22, the processor 20 confirms whether there is an unperformed path calculation request left. A path calculation request received by the path computation element PCE 2 is stored in, for example, a queue in the processor 20. When there is an unperformed path calculation request left, the process of the processor 20 moves on to S23.

In S23, the topology information controller 22 monitors whether topology updating information is advertised in the control plane 200. When the topology updating information is advertised in the control plane 200, the topology information controller 22 performs, in S24, the update process of FIG. 21. In other words, the topology information controller 22 reflects the topology update performed in the transmission network in the topology information database TED 11. Further, the topology information controller 22 overwrites the secondary database 12 with the topology information stored in the updated topology information database TED 11. After that, the topology information controller 22 updates the secondary database 12 using the information stored in the management table 14. When the topology updating information is not advertised in the control plane 200, S24 is skipped.

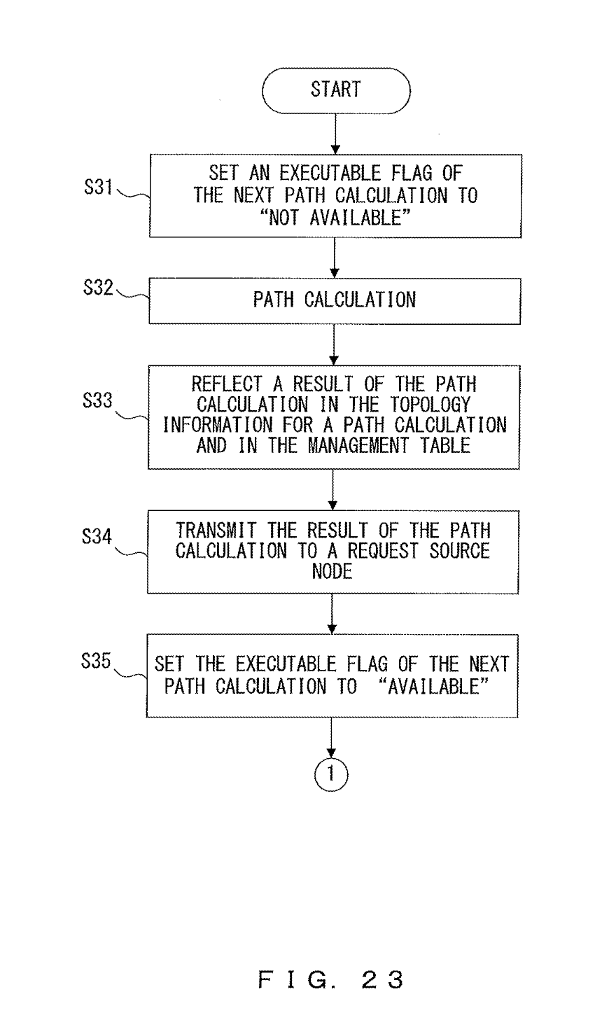

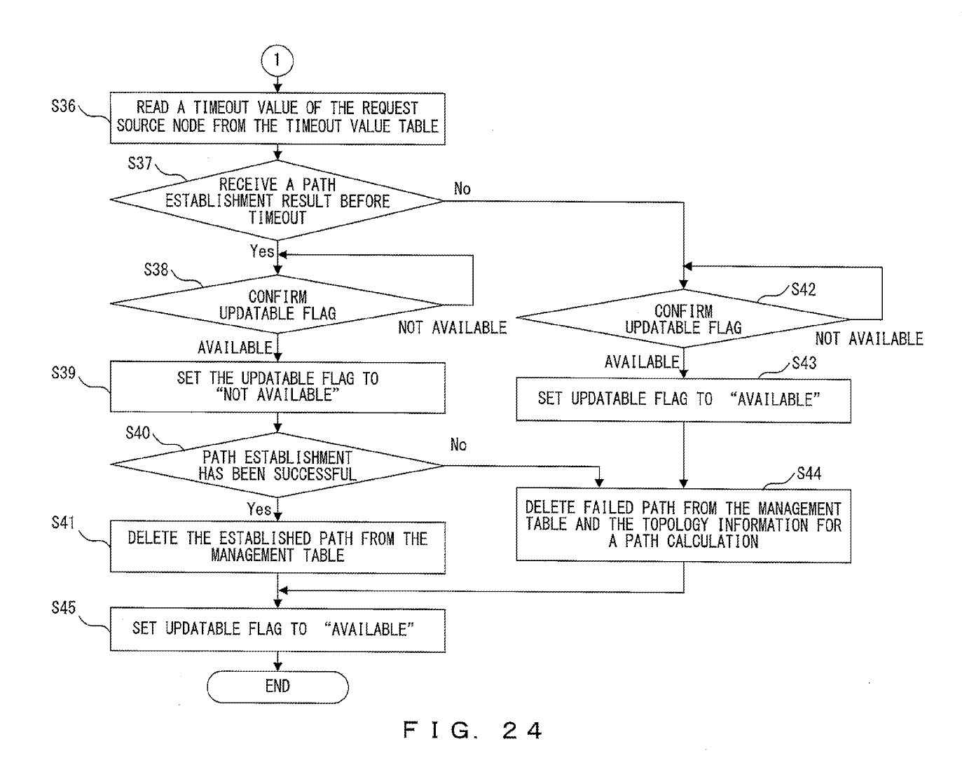

In S25 and S26, the processor 20 confirms an executable flag of the next path calculation request. When the executable flag of the next path calculation request is “available”, the processor 20 invokes a path calculation process in S27. In other words, the next path calculation request is given to the path calculator 21. The processing of the flowchart illustrated in FIG. 22 and the processing of the flowchart illustrated in FIGS. 23 and 24 can be performed in parallel.

FIGS. 23 and 24 are flowcharts that illustrate the path calculation process of the second embodiment. This process is invoked in S27 of FIG. 22.

In S31, the processor 20 sets an executable flag of the next path calculation request to “not available”. The executable flag is used for reporting, to the source that has invoked the process, whether a path calculation can be performed. In S32, the path calculator 21 performs the path calculation using topology information for a path calculation, and determines a path that satisfies the path calculation request. In S33, the topology information controller 22 reflects a result of the path calculation in the secondary database 12 and in the management table 14. In S34, the path calculator 21 transmits, to a node that has issued the path calculation request, a path-calculation-result reporting message including path information that indicates the result of the path calculation. Here, the processor 20 initiates a timer. In S35, the processor 20 sets the executable flag of the path calculation request to “available”.

In S36, the processor 20 obtains, from the timeout value table 13, a timeout value corresponding to the node that has issued the path calculation request. In S37, the processor 20 determines whether a path-establishment-result reporting message has been received before the elapse of the time indicated by the timeout value. When the path-establishment-result reporting message has been received before the timeout, the processor 20 confirms an updatable flag in S38 and S39. When the updatable flag is “available”, the processor 20 sets the updatable flag to “not available”. The updatable flag indicates whether the management table 14 can be updated.

In S40, the processor 20 refers to the received path-calculation-result reporting message, and determines whether a path establishment has been successful in the transmission network. When the path establishment has been successful, in S41, the topology information controller 22 deletes, from the management table 14, information that corresponds to the path established in the transmission network. Here, the topology information controller 22 does not update the secondary database 12. After that, in S45, the processor 20 sets the updatable flag to “available”.

When the path-establishment-result reporting message has not been received before the timeout, the processor 20 confirms an updatable flag in S42 and S43. When the updatable flag is “available”, the processor 20 sets this updatable flag to “not available”. After that, in S44, the topology information controller 22 deletes, from the secondary database 12 and the management table 14, the information that corresponds to the path established in the transmission network. When the path establishment has failed (S40: No), in S44, the topology information controller 22 also deletes, from the secondary database 12 and the management table 14, the information that corresponds to the path established in the transmission network.

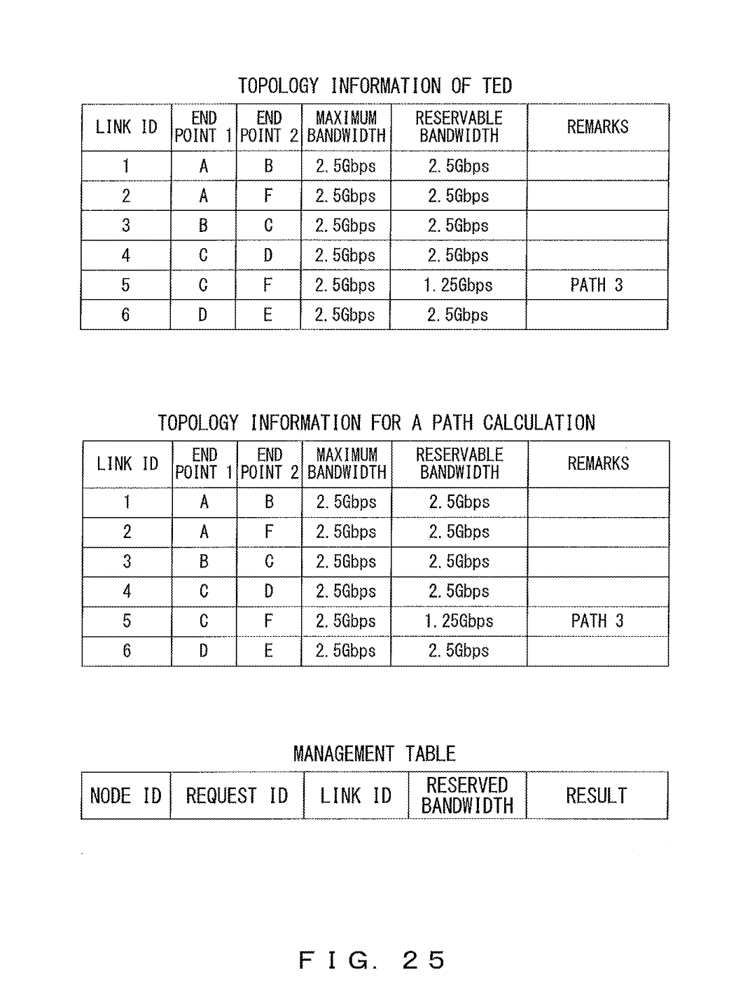

FIGS. 25-32 illustrate examples of operations of the path computation element PCE 2 according to the second embodiment. The configuration of the transmission network is similar to that of the embodiment illustrated in FIG. 8. In other words, the transmission network includes nodes A to F. In a data plane, links are respectively provided between the nodes A and B, the nodes A and F, the nodes B and C, the nodes C and D, the nodes C and F, and the nodes D and E. A bandwidth of each of the links is 2.5 Gbps. Further, as illustrated in FIG. 8, a path 3 that transmits a signal of 1.25 Gbps is established from the node F to the node C.

Here, topology information stored in the topology information database TED 11 and topology information for a path calculation stored in the secondary database 12 are as illustrated in FIG. 25. Further, at this point, nothing is registered in the management table 14, as illustrated in FIG. 25.

In the transmission network having the above-mentioned configuration, a path calculation request 1 and a path calculation request 2 below are respectively issued by the node F and the node A almost at the same time.

Path calculation request 1: start point=F, end point=D, bandwidth=1.25 Gbps
Path calculation request 2: start point=A, end point=D, bandwidth=1.25 Gbps
The path computation element PCE 2 receives the path calculation request 1 and the path calculation request 2. Then, the path computation element PCE 2 performs a path calculation in response to the path calculation request 1 first.

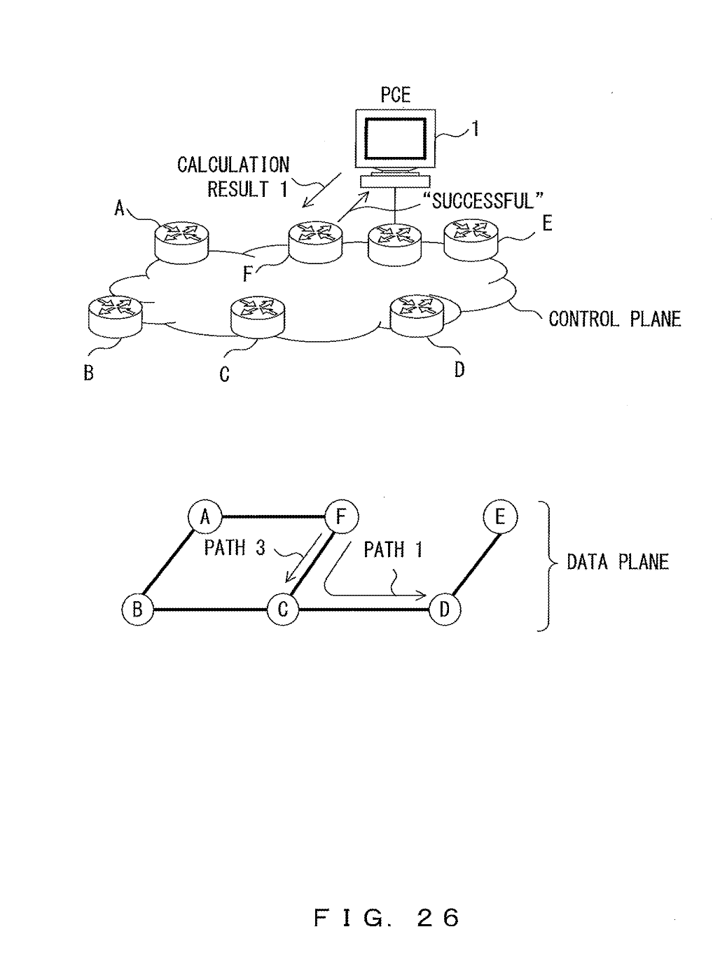

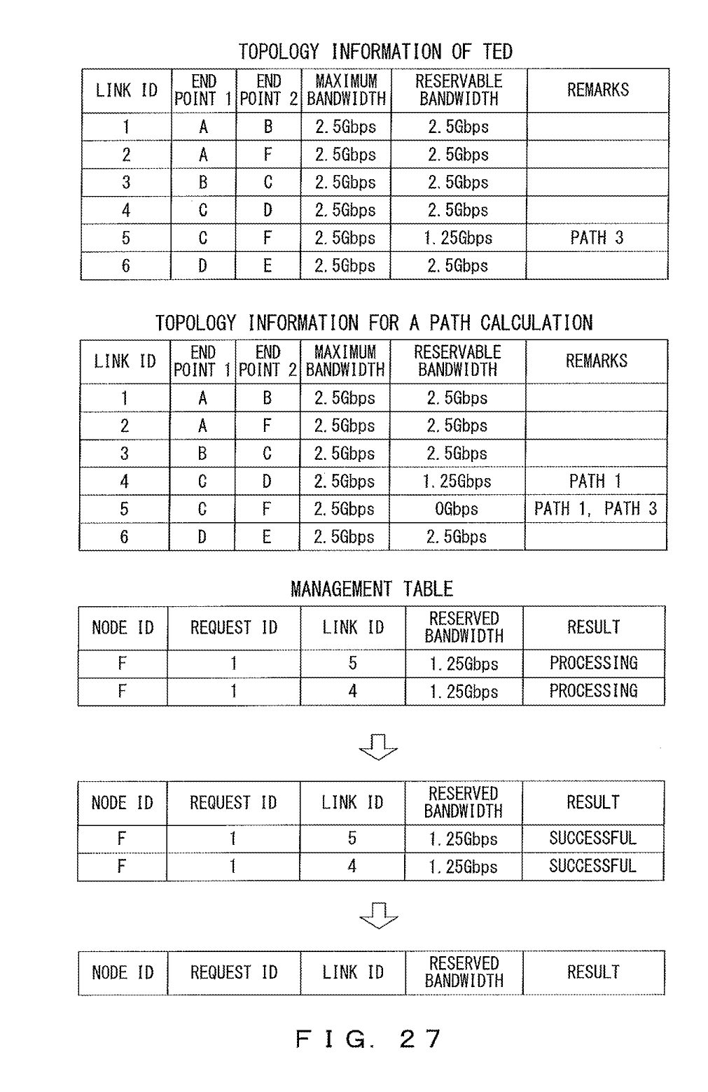

The path calculator 21 performs a path calculation using the topology information for a path calculation stored in the secondary database 12, and determines a path that satisfies the path calculation request 1. In this example, a path route “F→C→D” that indicates the path 1 of FIG. 26 is determined for the path calculation request 1. Then, the topology information controller 22 updates the topology information for a path calculation according to the path determined by the path calculator 21. Specifically, the bandwidth of the path 1 is subtracted from each of the reservable bandwidths of a link CD and a link CF on which the path 1 is established. In other words, the reservable bandwidth of the link CD is updated from “2.5 Gbps” to “1.25 Gbps”, and the reservable bandwidth of the link CF is updated from “1.25 Gbps” to “zero” in the topology information for a path calculation, as illustrated in FIG. 27.

As illustrated in FIG. 27, the topology information controller 22 registers, in the management table 14, path information that indicates the path 1 that corresponds to the path calculation request 1. The link ID=5 identifies the link CF, and the link ID=4 identifies the link CD. The bandwidth of the path 1 is 1.25 Gbps, so a bandwidth 1.25 Gbps has been reserved respectively for the link CF and link CD.

However, at this point, the path 1 has not actually been established yet. In other words, an actual topology in the transmission network and a topology indicated by the topology information for a path calculation are different from each other. Path information registered in the management table 14 indicates a difference between the actual topology and the topology indicated by the topology information for a path calculation.

After that, as illustrated in FIG. 26, the processor 20 transmits, to the node F, path information 1 that indicates a calculation result that has been obtained for the path calculation request 1. Here, the processor 20 obtains a timeout value of the node F from the timeout value table 13, and starts a timer.

The node F starts a process of reserving a bandwidth of the path 1 according to the path information 1 received from the path computation element PCE 2. As a result, bandwidths for establishing the path 1 are reserved on the link CD and the link CF. Then, when a path establishment has been successful, the node F transmits, to the path computation element PCE 2, a path-establishment-result reporting message indicating that the path establishment has been successful.

When the path computation element PCE 2 receives a path-establishment-result reporting message “successful” before the above-mentioned timer times out, the topology information controller 22 updates the result field in the management table 14 from “processing” to “successful”. In this case, the topology information controller 22 deletes information related to a link corresponding to the path 1 from the management table 14 without updating the secondary database 12.

Next, the path calculator 21 performs a path calculation using the topology information for a path calculation stored in the secondary database 12, and determines a path that satisfies the path calculation request 2. At this point, the topology information for a path calculation has been updated to the state illustrated in FIG. 27. In other words, the reservable bandwidth of the link CF is “zero”. Thus, the path calculator 21 determines a path that satisfies the path calculation request 2 without using the link CF.

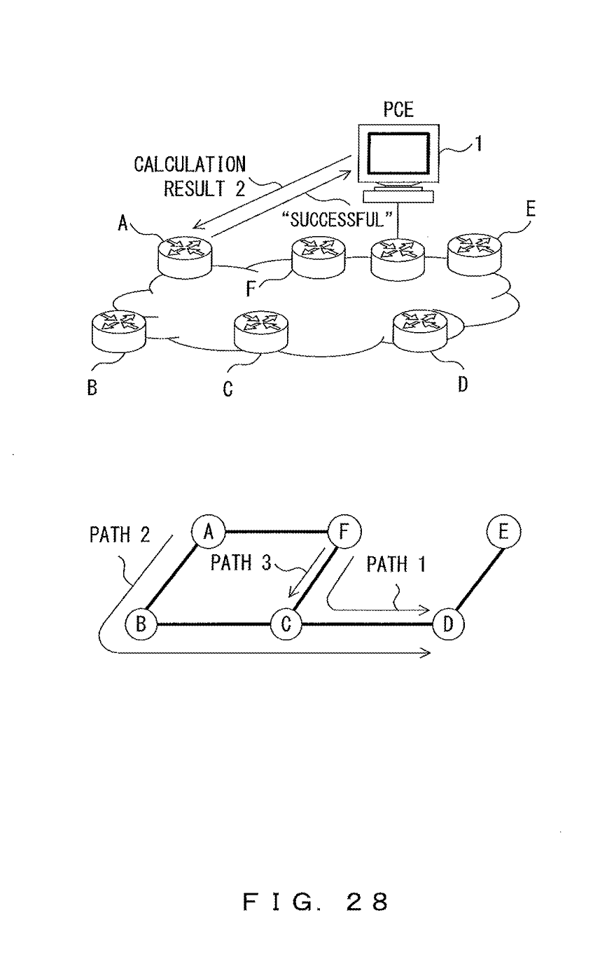

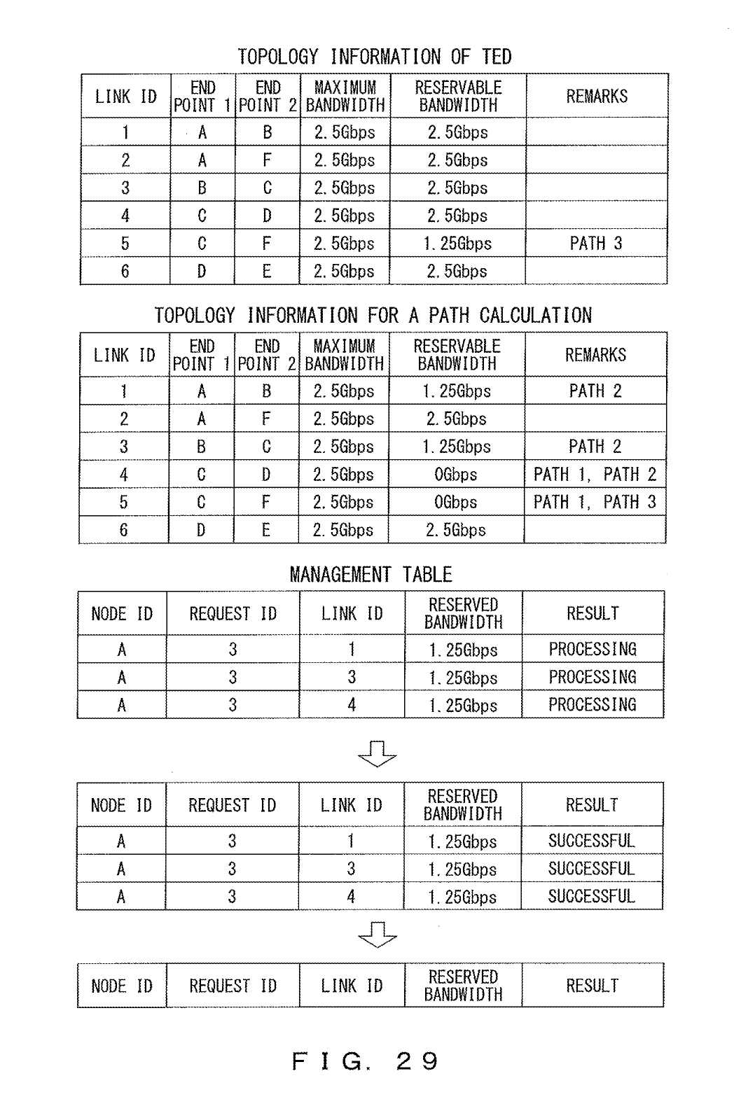

As a result, in this example, a path route “A→B→C→D” that indicates the path 2 of FIG. 28 is determined for the path calculation request 2. Then, the topology information controller 22 updates the topology information for a path calculation according to the determined path. Specifically, the bandwidth of the path 2 is subtracted from each of the reservable bandwidths of a link AB, a link BC, and the link CD on which the path 2 corresponding to the path calculation request 2 is established. As a result, the reservable bandwidth of the link AB is updated from “2.5 Gbps” to “1.25 Gbps”, the reservable bandwidth of the link BC is updated from “2.5 Gbps” to “1.25 Gbps”, and the reservable bandwidth of the link CD is updated from “1.25 Gbps” to “zero” in the topology information for a path calculation, as illustrated in FIG. 29. Here, the topology information for a path calculation indicates a state in which the path 1 and the path 2 have been established in the transmission network.

Further, as illustrated in FIG. 29, the topology information controller 22 registers, in the management table 14, path information that indicates the path 2 that corresponds to the path calculation request 2. The link ID=1 identifies the link AB, the link ID=3 identifies the link BC, and the link ID=4 identifies the link CD. A bandwidth 1.25 Gbps has been reserved respectively for the link AB, link BC, and link CD.

After that, as illustrated in FIG. 28, the processor 20 transmits, to the node A, path information 2 that indicates a calculation result for the path calculation request 2. Here, the processor 20 obtains a timeout value of the node A from the timeout value table 13, and initiates a timer.

The node A starts a process of reserving a bandwidth of the path 2 according to the path information 2 received from the path computation element PCE 2. As a result, bandwidths for establishing the path 2 are reserved on the link AB, the link BC, and the link CD. Then, when a path establishment has been successful, the node A transmits, to the path computation element PCE 2, a path-establishment-result reporting message indicating that the path establishment has been successful.

When the path computation element PCE 2 receives a path-establishment-result reporting message “successful” before the above-mentioned timer times out, the topology information controller 22 updates the result field in the management table 14 from “processing” to “successful”. In this case, the topology information controller 22 deletes information related to a link corresponding to the path 2 from the management table 14 without updating the secondary database 12.

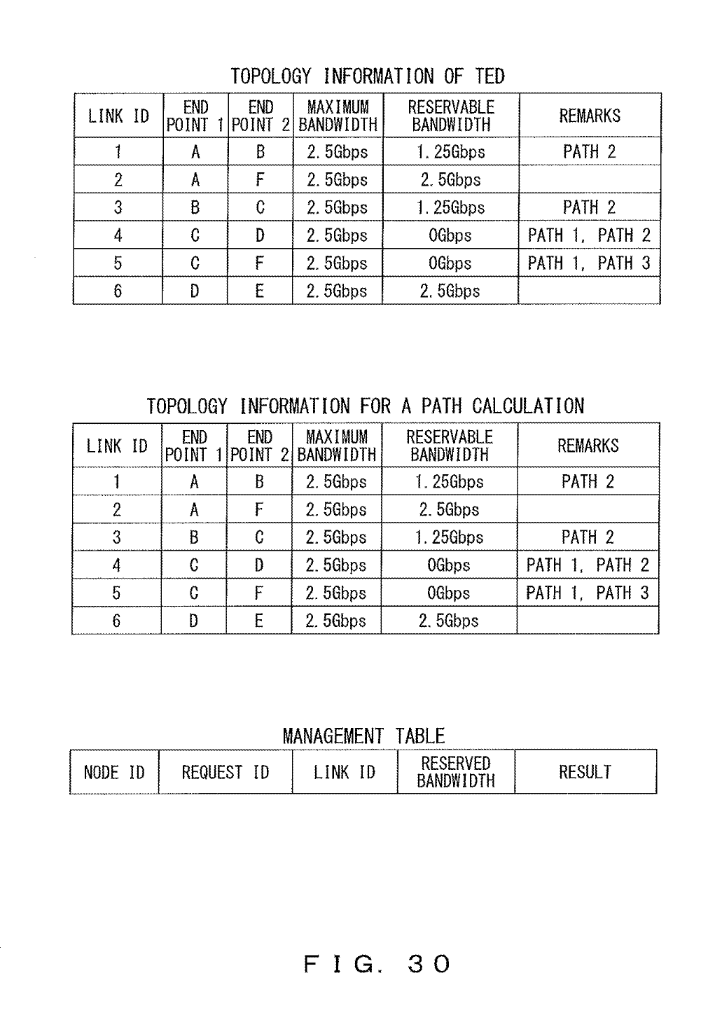

In the control plane, topology updating information is advertised when the topology of the data plane is updated. In other words, pieces of topology updating information indicating that the path 1 and the path 2 have been added are advertised. Then, when the path computation element PCE 2 receives the pieces of topology updating information, as illustrated in FIG. 30, the topology information controller updates the topology information database TED 11. Specifically, the path 1 and the path 2 are registered in the topology information database TED 11.

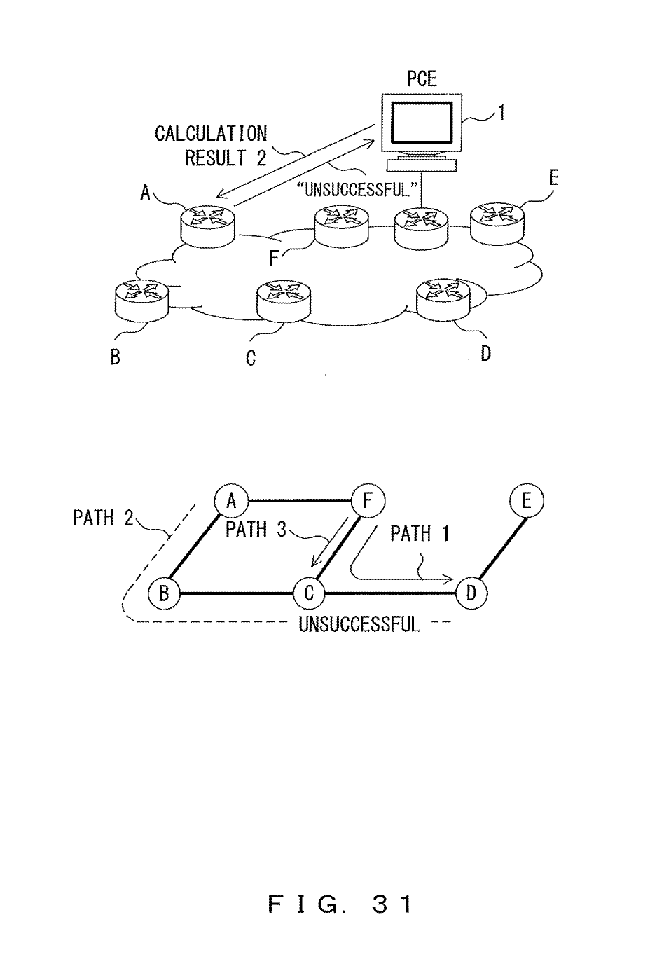

In the examples illustrated in FIGS. 26-30, the paths determined by the path computation element PCE 2 have been established in the transmission network. In other words, the path establishment has been successful. On the other hand, in the example illustrated in FIG. 31, the establishment of the path 2 fails. In this case, the node A transmits, to the path computation element PCE 2, a path-establishment-result reporting message indicating that the path establishment has failed.

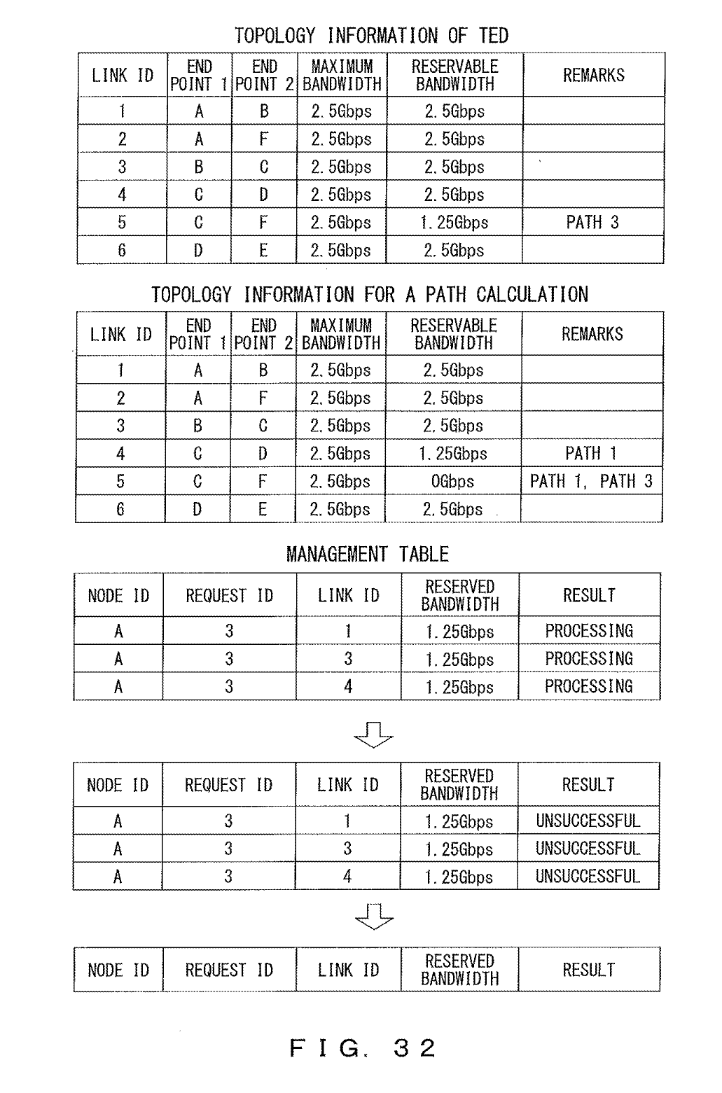

When the path computation element PCE 2 receives a path-establishment-result reporting message “unsuccessful” from the node A, the topology information controller 22 updates the result field in the management table 14 from “processing” to “unsuccessful”. In this case, the topology information controller 22 restores, according to the management table 14, the topology information for a path calculation to a state before a path calculation is performed. In this embodiment, the topology information controller 22 deletes the path 2 from the topology information for a path calculation. Here, the topology information controller 22 adds a corresponding reserved bandwidth in the management table 14 to the reservable bandwidth of a link to which the path 2 has been allocated in the topology information for a path calculation. In other words, as illustrated in FIG. 32, the reservable bandwidth of the link AB (link ID=1) is updated from “1.25 Gbps” to “2.5 Gbps”, the reservable bandwidth of the link BC (link ID=3) is updated from “1.25 Gbps” to “2.5 Gbps”, and the reservable bandwidth of the link CD (link ID=4) is updated from “zero” to “1.25 Gbps”. After that, the topology information controller 22 deletes information related to a link corresponding to the path 2 from the management table 14.

As described above, in the second embodiment, when a path establishment has failed in the transmission network, the topology information for a path calculation is restored to a state before a path calculation is performed. In other words, the topology information for a path calculation is updated to a state that indicates an actual topology in the transmission network. Thus, a communication resource released in the topology information for a path calculation (here, a bandwidth) can be allocated to another path, which provides greater flexibility in path calculation.

When the path computation element PCE 2 has not received a path-establishment-result reporting message within a period of time indicated by a timeout value, the processor 20 decides that a path establishment has failed in the transmission network. In this case, the topology information controller 22 performs processing similar to when a path-establishment-result reporting message “unsuccessful” is received.

<Hardware Configuration of a Path Calculation Device>

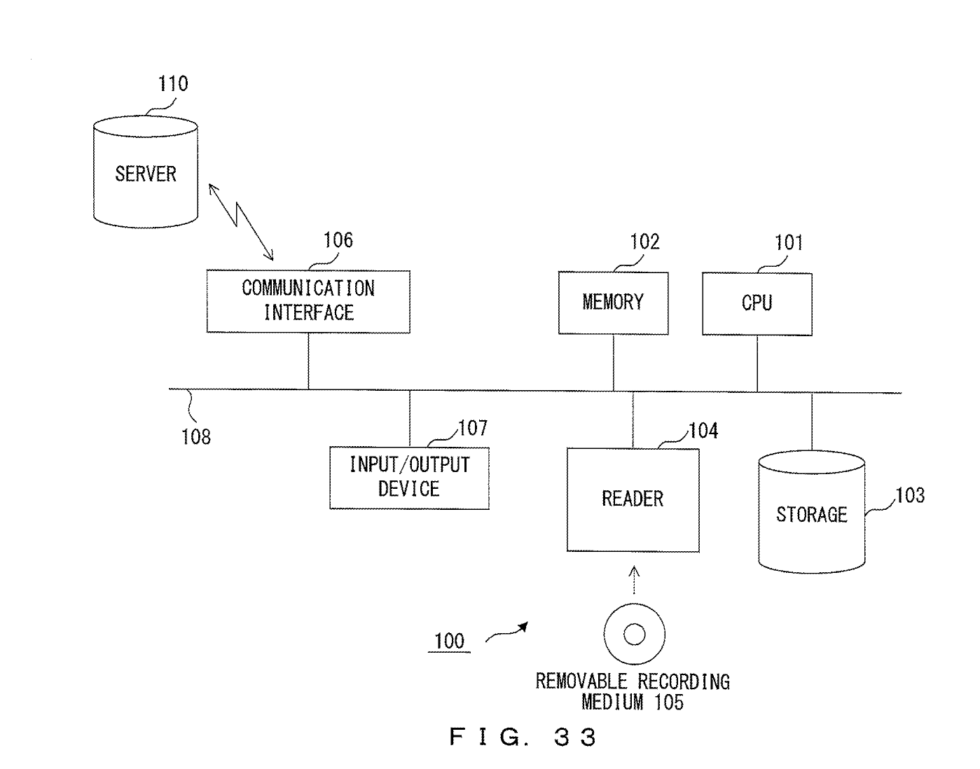

FIG. 33 illustrates an example of a hardware configuration of a path calculation device according to the embodiments of the present invention (PCE 1 or PCE 2). The path calculation device includes a computer system 100 illustrated in FIG. 33. The computer system 100 includes a CPU 101, a memory 102, a storage 103, a reader 104, a communication interface 106, and an input/output device 107. The CPU 101, the memory 102, the storage 103, the reader 104, the communication interface 106, and the input/output device 107 are connected to one another via, for example, a bus 108.

The CPU 101 executes, by use of the memory 102, a path calculation program in which the processing of the flowcharts described in FIG. 7 and FIGS. 22 to 24 is described. By doing this, the path calculation method according to the embodiments can be implemented. The memory 102 is, for example, a semiconductor memory, and is configured to include a RAM area and a ROM area. The storage 103 is, for example, a hard disk, and stores therein the path calculation program mentioned above. The storage 103 may be a semiconductor memory such as a flash memory. The storage 103 may be an external recording device.

The reader 104 accesses a removable recording medium 105 according to an instruction issued by the CPU 101. For example, the removable recording medium 105 is implemented by a semiconductor device (such as a USB memory), a medium to/from which information is input/output by magnetic action (such as a magnetic disk), and a medium to/from which information is input/output by optical action (such as a CD-ROM and a DVD). The communication interface 106 is able to transmit and receive data via a network according to an instruction issued by the CPU 101. The input/output device 107 includes, for example, a device that receives instructions from a user.

The processor 20 may be implemented by, for example, the CPU 101. The storage 10 may be implemented by, for example, the memory 101 and/or the storage 103. The communication IF unit 30 may be implemented by, for example, the communication interface 106.

The path calculation program of the embodiments are provided to the computer system 100, for example, in the following state:

(1) Preinstalled in the storage 103
(2) Provided by the removable recording medium 105
(3) Provided from a program server 110

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A path calculation device comprising:
a first storage that stores first topology information for indicating a topology of a network;
a second storage that stores second topology information generated from the first topology information stored in the first storage; and
a processor that determines a path between a start point and an endpoint based on the second topology information stored in the second storage and provides path information for indicating the determined path to the network when the path calculation device receives a path calculation request that includes information for indicating the start point and the end point from the network, wherein
the processor updates the second topology information stored in the second storage based on the determined path.

2. The path calculation device according to claim 1, wherein the processor updates the second topology information stored in the second storage from a first state that indicates a topology of the network when the determined path is not established to a second state that indicates a topology of the network when the determined path is established.

3. The path calculation device according to claim 1, wherein
the processor determines a route, on which the path between the start point and the end point is established, that satisfies a given constraint condition based on the second topology information stored in the second storage, and
the processor subtracts a bandwidth of the determined path from a reservable bandwidth of the route in the second topology information stored in the second storage.

4. The path calculation device according to claim 1, wherein
the processor updates the first topology information stored in the first storage based on update information that indicates an update of a topology of the network, the update information is advertised in the network.

5. The path calculation device according to claim 4, wherein
when the second topology information stored in the second storage does not match the first topology information stored in the first storage within a specified period of time since the processor provided the path information to the network, the processor updates the second topology information stored in the second storage such that the second topology information stored in the second storage matches the first topology information stored in the first storage.

6. The path calculation device according to claim 1 further comprising:
a third storage that stores information for indicating a route on which the path determined by the processor is established and a bandwidth of the determined path, wherein
the processor restores the second topology information stored in the second storage to a state before updated by the processor based on the information stored in the third storage when the path calculation device receives a report for indicating that a path establishment has failed from the network.

7. The path calculation device according to claim 1 further comprising:
a third storage that stores information for indicating a route on which the path determined by the processor is established and a bandwidth of the determined path, wherein
the processor restores the second topology information stored in the second storage to a state before updated by the processor based on the information stored in the third storage when the path calculation device does not receive a report for indicating a result of establishing the path within a specified period of time since the processor provided the path information to the network.

8. A path calculation method for determining a path established in a network that includes a plurality of nodes, the method comprising:
obtaining topology information that indicates a topology of the network, the topology information being advertised in the network;
storing the topology information obtained from the network in a first storage;
obtaining the topology information from the first storage;
storing the topology information obtained from the first storage in a second storage;
determining a path between a start point and an endpoint based on the topology information stored in the second storage when receiving a path calculation request that includes information for indicating the start point and the end point from the network;
providing path information for indicating the determined path to the network; and
updating the topology information stored in the second storage based on the determined path.
